(19) United States
(12) Patent Application Publication
(10) Pub. No.: US 2026/0073876 A1
(43) Pub. Date: Mar. 12, 2026

(54) GATE DRIVING CIRCUIT, AND DISPLAY PANEL AND DISPLAY DEVICE INCLUDING THE GATE DRIVING CIRCUIT

(71) Applicant: LG Display Co., Ltd., Seoul (KR)

(72) Inventors: Boo Heung LEE, Paju-si (KR); Hyeon Ju TAK, Paju-si (KR)

(73) Assignee: LG Display Co., Ltd., Seoul (KR)

(21) Appl. No.: 19/284,380

(22) Filed: Jul. 29, 2025

(30) Foreign Application Priority Data
Sep. 6, 2024 (KR) 10-2024-0121273

(51) Int. Cl. G09G 3/3266; G09G 3/3233

(52) U.S. Cl. CPC G09G 3/3266; G09G 3/3233; G09G 2300/0426; G09G 2300/0819; G09G 2300/0852; G09G 2310/0286; G09G 2310/04; G09G 2310/08; G09G 2330/021; G09G 2340/0435

(57) ABSTRACT

A gate driving circuit, and a display panel and display device including the gate driving circuit are discussed. The display device in an example includes a first switching transistor connected between an output node of a first signal transmitter from which a first gate signal is output and a first gate line, a second switching transistor connected to the output node of the first signal transmitter, a first diode connected between the second switching transistor and the first gate line, a third switching transistor connected between an output node of a second signal transmitter from which a second gate signal is output and a second gate line, a fourth switching transistor connected to the output node of the second signal transmitter, and a second diode connected between the fourth switching transistor and the second gate line.

### CROSS-REFERENCE TO RELATED APPLICATION

This application claims priority to and the benefit of Korean Patent Application No. 10-2024-0121273, filed in the Republic of Korea on Sep. 6, 2024, the disclosure of which is hereby expressly incorporated by reference in its entirety into the present application.

### BACKGROUND

### Field

The present disclosure relates to a gate driving circuit, and a display panel and display device including the gate driving circuit.

### Discussion of the Related Art

Electroluminescent display devices have the advantages of high response rate, excellent luminous efficiency, high luminance, and a large viewing angle by locating a self-luminescent element, such as an organic light emitting diode (hereinafter referred to as “OLED”) in each of the sub-pixels. The electroluminescent display device not only has a high response rate and excellent luminous efficiency, high luminance, and a large viewing angle, but also has an excellent contrast ratio and a high color reproduction rate because they can express black gradations as complete black. These electroluminescent display devices do not require a backlight unit and can be implemented on flexible materials such as plastic substrates, thin glass substrates, and metal substrates.

Various research efforts are underway to further reduce the power consumption in the electroluminescent display devices. For example, variable refresh rate (VRR) technology can be applied to the electroluminescent display devices. However, in order to implement the VRR technology, many circuit elements need to be added to a gate driving circuit, which can result in a decrease in the yield of a display panel and an increase in the non-display area of the display panel.

### SUMMARY OF THE DISCLOSURE

The present disclosure has been made in an effort to address the aforementioned necessities and/or drawbacks.

The present disclosure provides a gate driving circuit capable of reducing power consumption, and a display panel and a display device including the gate driving circuit.

An object of the present disclosure is not limited to the above-mentioned problems, and other objects not mentioned will be clearly understood by those skilled in the art from the following description.

A gate driving circuit according to one or more embodiments of the present disclosure includes: a first switching transistor connected between an output node of a first signal transmitter from which a first gate signal is output and a first gate line; a second switching transistor connected to the output node of the first signal transmitter; a first diode connected between the second switching transistor and the first gate line; a third switching transistor connected between an output node of a second signal transmitter from which a second gate signal is output and a second gate line; a fourth switching transistor connected to the output node of the second signal transmitter; and a second diode connected between the fourth switching transistor and the second gate line.

According to some embodiments of the present disclosure, the first diode can include a cathode electrode connected to the second switching transistor and an anode electrode connected to the first gate line. The second diode can include a cathode electrode connected to the fourth switching transistor and an anode electrode connected to the second gate line.

According to some embodiments of the present disclosure, the first diode can include an anode electrode connected to the second switching transistor and a cathode electrode connected to the first gate line. The second diode can include an anode electrode connected to the fourth switching transistor and a cathode electrode connected to the second gate line.

According to some embodiments of the present disclosure, each of the first and second diodes can include a transistor having a gate connected to one of the first and second electrodes.

According to some embodiments of the present disclosure, the first signal transmitter can include: a first-first input node to which a start pulse or a carry signal is input; and a second-first input node to which a first clock is input. The first gate signal and a first carry signal can be output through the output node of the first signal transmitter. The second signal transmitter can include a first-second input node to which the first carry signal is input; and a second-second input node to which a second clock having a phase different from that of the first clock is input. The second gate signal and a second carry signal can be output through the output node of the second signal transmitter.

According to some embodiments of the present disclosure, at least one of the first and second gate lines can be branched into two gate lines.

A display panel according to one or more embodiments of the present disclosure includes: a display area in which a plurality of data lines, a plurality of gate lines, a plurality of power lines, and a plurality of sub-pixels are arranged; and a plurality of gate drivers that supply gate signals to the gate lines. At least one of the gate drivers includes: a first switching transistor connected between an output node of a first signal transmitter from which a first gate signal is output and a first gate line; a second switching transistor connected to the output node of the first signal transmitter; a first diode connected between the second switching transistor and the first gate line; a third switching transistor connected between an output node of a second signal transmitter from which a second gate signal is output and a second gate line; a fourth switching transistor connected to the output node of the second signal transmitter; and a second diode connected between the fourth switching transistor and the second gate line.

A display device according to one or more embodiments of the present disclosure includes: a display panel including a display area in which a plurality of data lines, a plurality of gate lines, a plurality of power lines, and a plurality of sub-pixels are arranged; and a plurality of gate drivers supplying gate signals to the gate lines; and a data driver connected to the data lines. The display area includes at least first and second pixel areas having different refresh rates, and the sub-pixels of the first pixel area are driven at a first refresh rate, while the sub-pixels of the second pixel area are driven at a second refresh rate that is lower than the first refresh rate. At least one of the gate drivers includes: a first switching transistor connected between an output node of a first signal transmitter from which a first gate signal is output and a first gate line; a second switching transistor connected to the output node of the first signal transmitter; a first diode connected between the second switching transistor and the first gate line; a third switching transistor connected between an output node of the second signal transmitter from which a second gate signal is output and a second gate line; a fourth switching transistor connected to the output node of the second signal transmitter; and a second diode connected between the fourth switching transistor and the second gate line.

According to aspects of the present disclosure, a refresh rate of pixels can be varied for each location of a display area by differently controlling a voltage level or a waveform of a gate signal between a refresh pixel and a skip pixel. As a result, the present disclosure can minimize power consumption without degrading image quality, thereby realizing low power driving and long life of the display device.

According to aspects of the present disclosure, when the waveform of the gate signal varied according to a refresh rate, a diode can be used to prevent a gate signal waveform error and a pixel malfunction.

According to aspects of the present disclosure, the number of transistors added to reduce the gate signal waveform and the number of wires connected to these transistors can be reduced by using a diode. As a result, the present disclosure can reduce the area occupied by a gate driver on a display panel.

The effects of the present disclosure are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a block diagram showing a display device according to one or more embodiments of the present disclosure;

FIG. 2 is a diagram showing a plurality of pixel areas in which a pixel driving frequency is independently controlled;

FIG. 3 is a diagram showing a multi-frequency control method of a timing controller;

FIG. 4 is a circuit diagram showing a pixel circuit according to a first embodiment of the present disclosure;

FIG. 5 is a waveform diagram showing an example of gate signals applied to the pixel circuit illustrated in FIG. 4 during a refresh period;

FIG. 6 is a circuit diagram showing transistors turned on/off in a data write step during the refresh period;

FIG. 7 is a waveform diagram showing an example of gate signals applied to the pixel circuit illustrated in FIG. 4 during a frame skip period;

FIG. 8 is a circuit diagram showing transistors turned on/off during a data skip step;

FIG. 9 is a circuit diagram showing a pixel circuit according to a second embodiment of the present disclosure;

FIG. 10 is a waveform diagram showing an example of gate signals applied to a pixel circuit illustrated in FIG. 9 during a refresh period;

FIG. 11 is a circuit diagram showing transistors turned on/off in a sampling step during the refresh period;

FIG. 12 is a circuit diagram showing transistors turned on/off in a data write step during the refresh period;

FIG. 13 is a waveform diagram showing an example of gate signals applied to the pixel circuit 101 illustrated in FIG. 9 during a frame skip period;

FIG. 14 is a circuit diagram showing transistors of an off state in a hold step and a data skip step of a frame skip period;

FIG. 15 is a circuit diagram showing a pixel circuit according to a third embodiment of the present disclosure;

FIG. 16 is a waveform diagram showing an example of gate signals applied to a pixel circuit illustrated in FIG. 15 during a refresh period;

FIG. 17 is a circuit diagram showing transistors turned on/off in an initialization step during the refresh period;

FIG. 18 is a circuit diagram showing transistors turned on/off in a data write step during the refresh period;

FIG. 19 is a waveform diagram showing an example of gate signals applied to the pixel circuit illustrated in FIG. 15 during a frame skip period;

FIG. 20 is a circuit diagram showing transistors in the off state in a hold step and a data skip step during a frame skip period;

FIG. 21 is a diagram showing a connection structure of sub-pixels and signal wires that is advantageous for simultaneously driving adjacent pixel lines to secure a sampling time;

FIG. 22 is a diagram showing first to fourth gate drivers for driving the pixel circuit illustrated in FIG. 4;

FIG. 23 is a waveform diagram showing clocks and start pulses input to the gate drivers illustrated in FIG. 22;

FIG. 24 is a circuit diagram showing a signal transmitter circuit of a gate driver according to one embodiment of the present disclosure;

FIG. 25 is a circuit diagram showing switching circuits and diodes of a gate driver according to the first embodiment of the present disclosure;

FIG. 26 is a waveform diagram showing input/output signals of the gate driver illustrated in FIG. 25;

FIG. 27A to FIG. 31B are diagrams showing the operation of the gate driver illustrated in FIG. 25 step by step on the time axis;

FIG. 32 is a circuit diagram showing switching circuits and diodes of a gate driver according to the second embodiment of the present disclosure;

FIG. 33 is a circuit diagram showing switching circuits and diodes of a gate driver according to the third embodiment of the present disclosure; and

FIG. 34 is a waveform diagram showing the input/output signals of the gate driver illustrated in FIG. 33.

### DETAILED DESCRIPTION OF THE EMBODIMENTS

The advantages and features of the present disclosure and methods for accomplishing the same will be more clearly understood from embodiments described below with reference to the accompanying drawings. However, the present disclosure is not limited to the following embodiments but can be implemented in various different forms. Rather, the present embodiments will make the disclosure of the present disclosure complete and allow those skilled in the art to completely comprehend the scope of the present disclosure. The present disclosure is only defined within the scope of the accompanying claims.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present disclosure. Further, in describing the present disclosure, detailed descriptions of known related technologies can be omitted to avoid unnecessarily obscuring the subject matter of the present disclosure.

The terms such as “comprising,” “including,” “having,” and “containing” used herein are generally intended to allow other components to be added unless the terms are used with the term “only. ”Any references to singular can include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components can be interposed between them, unless “immediately”or “directly”is used.

When a temporal antecedent relationship is described, such as “after”, “following”, “next to”, “before”, or the like, it may not be continuous on a time base unless “immediately” or “directly”is used.

The terms “first,” “second,” and the like can be used to distinguish elements from each other, but the functions or structures of the components are not limited by ordinal numbers or component names in front of the components, and may not define order or sequence. Further, the term “can”fully encompasses all the meanings and coverages of the term “may”and vice versa.

The following embodiments can be partially or entirely bonded to or combined with each other and can be linked and operated in technically various ways. The embodiments can be carried out independently of or in association with each other.

The pixel circuit and the gate drive circuit of the display device can include a plurality of transistors.

Active layers of the thin-film transistors TFTs may be formed of a semiconductor material, such as an oxide semiconductor, amorphous semiconductor, or polycrystalline semiconductor, but is not limited thereto.

The oxide semiconductor material may have an excellent effect of preventing a leakage current and relatively inexpensive manufacturing cost. The oxide semiconductor may be made of a metal oxide such as zinc (Zn), indium (In), gallium (Ga), tin (Sn), and titanium (Ti) or a combination of a metal such as zinc (Zn), indium (In), gallium (Ga), tin (Sn), or titanium (Ti) and its oxide. Specifically, the oxide semiconductor may include zinc oxide (ZnO), zinc-tin oxide (ZTO), zinc-indium oxide (ZIO), indium oxide (InO), titanium oxide (TiO), indium-gallium-zinc oxide (IGZO), indium-zinc-tin oxide (IZTO), indium zinc oxide (IZO), indium gallium tin oxide (IGTO), and indium gallium oxide (IGO), but is not limited thereto.

The polycrystalline semiconductor material has a fast movement speed of carriers such as electrons and holes and thus has high mobility, and has low energy power consumption and superior reliability. The polycrystalline semiconductor may be made of polycrystalline silicon (poly-Si), but is not limited thereto.

The amorphous semiconductor material may be made of amorphous silicon (a-Si), but is not limited thereto.

For example, the transistor can be implemented as a thin film transistor (TFT). The transistors can be implemented as an oxide thin film transistor (Oxide TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons can flow from a source to a drain. The n-channel transistor has a direction of a current flowing from the drain to the source. In the case of a p-channel transistor, since carriers are holes, a source voltage is higher than a drain voltage such that holes can flow from a source to a drain. In the p-channel transistor, since holes flow from the source to the drain, current flows from the source to the drain. It should be noted that a source and a drain of a transistor are not fixed. For example, a source and a drain can be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage can be a gate high voltage VGH, and the gate-off voltage can be a gate low voltage VGL. In the case of a p-channel transistor, the gate-on voltage can be the gate low voltage VGL, and the gate-off voltage can be the gate high voltage VGH.

Hereinafter, various embodiments of the present disclosure will be described in detail with reference to the accompanying drawings. All the components of each display device and each gate driving circuit according to all embodiments of the present disclosure are operatively coupled and configured.

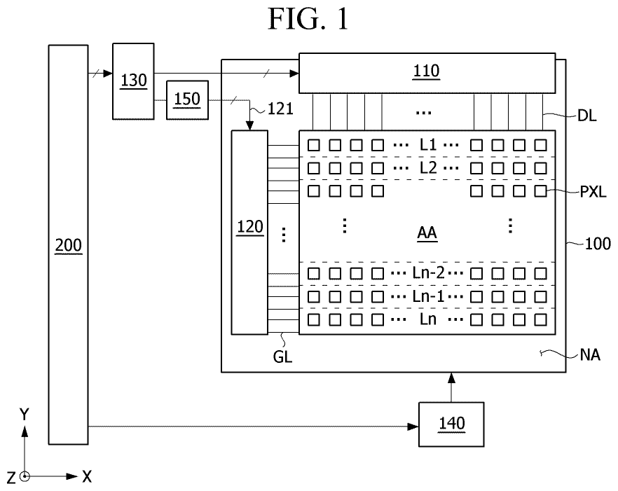

FIG. 1 is a block diagram showing a display device according to one or more embodiments of the present disclosure.

Referring to FIG. 1, a display device according to an embodiment of the present disclosure includes a display panel 100, a display panel driving circuit for writing pixel data to pixels of the display panel 100, and a power supply 140 for generating power required to drive the pixels and the display panel driving circuit.

The display panel 100 can include a display area (or active area) AA that displays an input image on a screen. A non-displayable or non-display area (or non-active area) NA can be placed outside the displayable area AA.

For example, the non-display area NA may be an area adjacent to the display area DA. Further, the non-display area NA may be an area disposed adjacent to the display area AA and configured to surround the display area DA. The non-display area NA may also be referred to as a non-active area or a bezel (or a bezel area). The non-display area NA may include a pad area located outside of (e.g., spaced apart from) the display area AA in a column direction. For example, the pad area may be a portion of the non-display area NDA.

For example, the non-display area NA may include a first non-display area, a second non-display area, a third non-display area, and a fourth non-display area. The first non-display area may be located outside of the display area AA in the column direction. The second non-display area may be located outside of the display area AA in a row direction. The third non-display area may be located outside of the display area AA in the column direction and located opposite to the first non-display area. The fourth non-display area may be located outside of the display area AA in the row direction and located opposite to the second non-display area. The first non-display area among the first to fourth non-display areas may include a pad area to which a driving circuit is connected or bonded. The second to fourth non-display areas that do not include the pad area among the first to fourth non-display areas may have a very small size, but aspects of the present disclosure are not limited thereto.

In one or more aspects, a boundary area between the display area AA and the non-display area NA may be bent, and in this structure, the non-display area NA may be located under the display area DA.

A substrate of the display panel 100 can be, but is not limited to, a plastic substrate, a thin glass substrate, or a metal substrate. For example, the substrate may include a flexible polymer film. For example, the flexible polymer film may be made of any one of polyimide (PI), polyethylene terephthalate (PET), acrylonitrile-butadiene-styrene copolymer (ABS), polymethyl methacrylate (PMMA), polyethylene naphthalate (PEN), polycarbonate (PC), polyethersulfone (PES), polyarylate (PAR), polysulfone (PSF), cyclic olefin copolymer (COC), triacetylcellulose (TAC), polyvinyl alcohol (PVA), and polystyrene (PS), and the present disclosure is not limited thereto. The display panel 100 can be, but is not limited to, a rectangular panel having a length in the X-axis direction (or a first direction), a width in the Y-axis direction (or a second direction), and a thickness in the Z-axis direction (or a third direction). For example, at least a portion of the display panel 100 can have a curved outer portion. The non-display area AA can surround the display area AA entirely or only in part(s).

The display panel 100 includes wires such as a plurality of data lines DL, a plurality of gate lines GL intersecting the data lines DL, and a plurality of power lines. The gate lines GL can be located on the display panel 100 in parallel with the first direction X, and the data lines DL can be located on the display panel 100 in parallel with the second direction Y. The pixels PXL in the display area AA are connected to the data lines DL, the gate lines GL, and the power lines. The power lines can be connected in common to the pixels PXL to supply a constant voltage required for driving the pixels PXL to the pixels PXL. The power lines can be implemented as long stripe wires in the first direction or the second direction, or can be implemented on the display panel 100 as mesh wires in which the wires in the first direction and the wires in the second direction are electrically connected.

The display area AA includes a plurality of pixel lines L1 to Ln. Here, n can be a real number such as a positive integer. Each of the pixel lines L1 to Ln includes one line of sub-pixels arranged along the first direction X of the display panel 100. The pixels arranged in one pixel line can share the gate lines GL. The sub-pixels of one column arranged along the second direction Y share the same data lines DL. One horizontal period is a time obtained by dividing one frame period by the total number of pixel lines L1 to Ln.

The display panel 100 can be implemented with a non-transmissive display panel or a transmissive display panel. The transmissive display panel can be applied to a transparent display device in which an image is displayed on a screen and an actual object in the background is visible. The display panel 100 can be manufactured as a flexible display panel.

Each of the plurality of subpixels is a minimum unit which configures the display area and n subpixels form one pixel. Each of the plurality of subpixels may emit light having different wavelengths from each other. The plurality of subpixels may include first to third subpixels which emit different color light from each other. For example, each of the pixels PXL may be divided into a red sub-pixel, a green sub-pixel, and a blue sub-pixel for color implementation. Each of the pixels may further include a white sub-pixel. The plurality of subpixels may be variously modified in colors and configurations, as necessary. However, the present disclosure is not limited thereto.

For example, the plurality of subpixels may include red, green, and blue subpixels, in which the red, green, and blue subpixels may be disposed in a repeated manner. Alternatively, the plurality of subpixels may include red, green, blue, and white subpixels, in which the red, green, blue, and white subpixels may be disposed in a repeated manner, or the red, green, blue, and white subpixels may be disposed in a quad type. For example, the red sub pixel, the blue sub pixel, and the green sub pixel may be sequentially disposed along a row direction, or the red sub pixel, the blue sub pixel, the green sub pixel and the white sub pixel may be sequentially disposed along the row direction. However, in the embodiment of the present disclosure, the color type, disposition type, and disposition order of the subpixels are not limiting, and may be configured in various forms according to light-emitting characteristics, device lifespans, and device specifications.

Meanwhile, the subpixels may have different light-emitting areas according to light-emitting characteristics. For example, a subpixel that emits light of a color different from that of a blue subpixel may have a different light-emitting area from that of the blue subpixel. For example, the red subpixel, the blue subpixel, and the green subpixel, or the red subpixel, the blue subpixel, the white subpixel, and the green subpixel may each has a different light-emitting area.

Each of the sub-pixels can include pixel circuits for driving light-emitting elements. Each of the pixel circuits can be connected to the data lines, the gate lines, and the power lines. In the following, a ‘pixel’ can be interpreted as a “sub-pixel”. Each of the sub-pixels includes a pixel circuit that drives a light-emitting element, such as an OLED.

For example, the pixel circuit of each of the plurality of subpixels may include a capacitor, at least one thin film transistor, and a light emitting element, such as an OLED. For example, the at least one thin film transistor may include a driving transistor, a first switching transistor, and a second switching transistor. In addition, the light emitting element may include a first electrode/a second electrode (or anode electrode, pixel electrode), an inorganic light emitting layer (or organic light emitting layer), and a second electrode/a first electrode (or cathode electrode, common electrode). However, the pixel circuit of each of the plurality of subpixels are not limited thereto, each of the plurality of subpixels may further include a compensation circuit. In this case, each of the plurality of subpixels may have various structures such as 4T2C, 5T2C, 6T1C, 6T2C, 7T1C, 7T2C, and the like.

The pixels PXL can be arranged as real color pixels and pentile pixels, but the embodiments of the present disclosure are not limited thereto. The pentile pixels can implement a higher resolution than real color pixels by driving two sub-pixels of different colors into one pixel PXL using a preset pixel rendering algorithm. The pixel rendering algorithm can compensate for the color expression insufficient in each of the pixels PXL with the color of light emitted from adjacent pixels PXL.

The driving circuit of the display panel 100 can include a data driver 110, a gate driver 120, a timing controller 130, a power supply 140, and a level shifter 150. In addition, the driving circuit of the display panel 100 can further include a touch sensor driver. The data driver 110 and the touch sensor driver can be integrated into one drive integrated circuit (IC). In a mobile terminal or wearable terminal, the timing controller 130, the power supply 140, the level shifter 150, the data driver 110, a touch sensor driver, and the like can be integrated into a single drive IC.

The driving circuit of the display panel 100 can be driven at a variable refresh rate (VRR) under the control of the timing controller 130. For example, the timing controller 130 can analyze an input image and reduce the power consumption of the display device by lowering the refresh rate when the input image does not change for a predetermined amount of time. In this case, the driving circuit of the display panel 100 can reduce the power consumption of the display device by controlling a data writing cycle of the pixels PXL to be longer by lowering the refresh rate of the pixels PXL when a still image is input for a certain period of time or longer under the control of the timing controller 130. The refresh rate of the driving circuit of the display panel 100 can be lower when the display device is operated in standby mode or in response to a user command. In addition, the refresh rate can be lower on an Always On Display (AOD) screen. The AOD screen is a partial pixel area of the display area AA in which the predetermined information, for example brief information such as remaining battery power, time, etc. is displayed in standby mode. The refresh rate can be interpreted as a driving frequency of the pixels PXL for updating data of the pixels.

The timing controller 130 can control the operation timing of the drivers 110 and 120 of the display panel 100 at a frame frequency of an input frame frequency×i Hz by multiplying the frame frequency of the input image by a factor of i (i is a natural number). The timing controller 130 can support variable refresh rates. For example, the timing controller 130 can lower the driving frequency of the pixels PXL to a frequency between 1 Hz and 30 Hz in a low-speed driving mode to lower the refresh rate of the pixels PXL.

The timing controller 130 can receive pixel data of an input image and a timing signal synchronized with the pixel data from a host system 200. The timing signal can include a vertical synchronization signal Vsync, a horizontal synchronization signal Hsync, a main clock CLK, and a data enable signal DE. One cycle of the vertical synchronization signal Vsync can be one frame period. One cycle of the horizontal synchronization signal Hsync and the data enable signal DE can be one horizontal period 1 H. The pulses of the data enable signal DE can be synchronized with one line of data to be written to the pixels PXL of one pixel line. Since the frame period and the horizontal period can be known by a method of counting the data enable signal DE, the vertical synchronization signal Vsync and the horizontal synchronization signal Hsync can be omitted. The timing controller 130 can transmit pixel data of an input image to the data driver 110 and control the operation timings of the data driver 110 and the gate driver 120.

The timing controller 130 may be configured to be coupled with various processors, for example, a microprocessor, a mobile processor, an application processor, etc. in accordance with a device mounted therein.

A host system, which is applied to the timing controller 130, may be one of a television (TV) system, a set-top box, a navigation system, a personal computer (PC), a home theater system, a mobile appliance, a wearable appliance, and a vehicle system.

The timing controller 130 may be implemented in a separate component from the data driver 110, or integrated with the data driver 110, so that the timing controller 130 and the data driver 110 can be implemented in a single integrated circuit.

The timing controller 130 may be a timing controller used in the typical display technology or a control apparatus/device capable of additionally performing other control functionalities in addition to the typical function of the timing controller. In one or more embodiments, the timing controller 130 may be one or more other control circuits different from the timing controller, or a circuit or component in the control apparatus/device. The timing controller 130 may be implemented using various circuits or electronic components such as an integrated circuit (IC), a field programmable gate array (FPGA), an application specific integrated circuit (ASIC), a processor, and/or the like.

The timing controller 130 may be mounted on a printed circuit board, a flexible printed circuit, or the like, and may be electrically connected to the data driver 110 and the gate driver 120 through the printed circuit board, the flexible printed circuit, and/or the like.

The timing controller 130 can transmit signals to, and receive signals from, the data driver 110 via one or more predetermined interfaces. For example, such interfaces may include a low voltage differential signaling (LVDS) interface, an embedded clock point-point interface (EPI), a serial peripheral interface (SPI), and the like. However, aspects of the present disclosure are not limited thereto.

A gate timing control signal generated from the timing controller 130 can be input to the gate driver 120 via the level shifter 150.

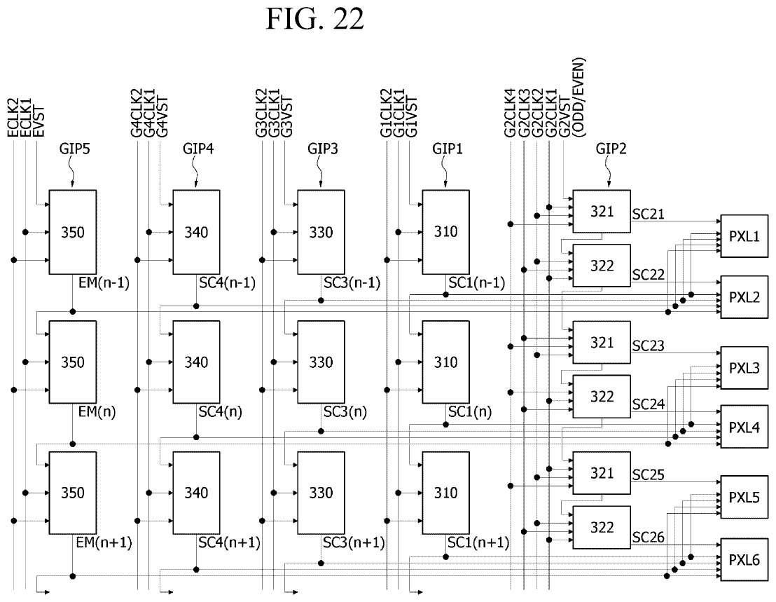

The level shifter 150 receives the gate timing control signal and outputs start pulses, clocks, and selection signals as shown in FIGS. 22 to 34. The input signal of the level shifter 150 can be a signal of a digital signal voltage level, and the output signal of the level shifter 150 can be an analog voltage signal that swings between a gate high voltage VGH and a gate low voltage VGL. The level shifter 150 can convert a low level voltage of the gate timing signal output from the timing controller 130 into the gate low voltage VGL and convert the high level voltage into the gate high voltage VGH. The output signals of the level shifter 150 are input to the gate driver 120.

The output signal of the level shifter 150 can be provided to the gate driver 120 through signal wires 121. The signal wires 121 can include clock wires through which a start pulse and a clock are transmitted, and selection signal wires through which a selection signal is transmitted.

The data driver 110 can receive pixel data of an input image as a digital signal from the timing controller 130 and output a data voltage. The data driver 110 can convert video data of an input image into a gamma compensated voltage using a digital-to-analog converter (hereinafter referred to as “DAC”) and output a data voltage. A gamma reference voltage GMA output from the power supply 140 can be divided into gamma compensated voltage for each gray level by a voltage distribution circuit of the data driver 110 and supplied to the DAC. The DAC can output a data voltage as a gamma compensated voltage corresponding to a grayscale value of pixel data. The data voltage output from the DAC can be output to the data line DL via an output buffer from each of the data output channels of the data driver 110.

The driving circuit of the display panel 100 can further include a de-multiplexer DEMUX located between the data driver 110 and the data lines DL. As another example, the demultiplexer can be omitted. The demultiplexer can sequentially distribute the data voltage output from the channels of the data driver 110 to the data lines DL. When a demultiplexer is added, the number of channels in the data driver 110 can be reduced.

The gate driver 120 can be located on the display panel 100. The gate driver 120 can be located in a non-display area NA outside the display area AA in the display panel 100, or can be located at least partially in the display area AA. The gate driver 120 can supply the gate signals to the gate lines GL in a single feeding manner. In the single feeding manner, the gate signal can be applied at one end of the gate line GL. In a double feeding manner, the gate signals can be applied simultaneously from both ends of the gate line GL.

The gate driver 120 can include one or more shift registers and/or edge triggers. The gate driver 120 can control each of the pixel lines L1 to LN as a pixel line in a pixel area with a high refresh rate or as a pixel line in a pixel area with a low refresh rate by varying a frequency of the gate signal applied to the gate lines under the control of the timing controller 130.

The power supply 140 can include a charge pump, a regulator, a buck converter, and a boost converter, but the embodiments of the present disclosure are not limited thereto. The power supply 140 can receive a direct current input voltage from the host system 200 and generate power required for driving the display panel 100 and the driver of the display panel 100. The power supply 140 can output a constant voltage (or DC voltage) such as a gamma reference voltage GMA, a gate high voltage VGH, and a gate low voltage VGL. In addition, the power supply 140 can output constant voltages provided to the pixel circuit. The gamma reference voltage GMA can be supplied to the data driver 110. The gate high voltage VGH and the gate low voltage VGL can be supplied to the level shifter 150 and the gate driver 120. The constant voltages input to the pixel circuit can be supplied to the pixels through power lines commonly connected to the pixels PXL.

The display device of the present disclosure supports multi-frequency driving method to reduce power consumption without deteriorating image quality. In the multi-frequency driving method, the display area AA of the display panel 100 can be divided into a plurality of pixel areas that can be driven at different pixel driving frequencies.

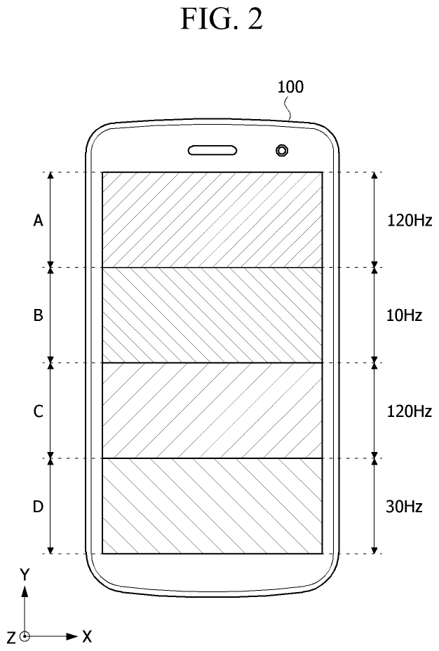

FIG. 2 is a diagram showing a plurality of pixel areas in which a pixel driving frequency is independently controlled.

Referring to FIG. 2, the display area AA can include two or more pixel areas A, B, C, and D. Each of the pixel regions A, B, C, and D can include one or more pixel lines. The timing controller 130 can independently control the refresh rate of pixels for each pixel area by controlling the data driver 110 and the gate driver 120. The timing controller 130 can increase the pixel driving frequency of pixel areas in which data updates are required at a high frequency, while lowering the pixel driving frequency of pixel areas in which image quality degradation is not recognized even with the data updates at a low-frequency.

For example, the refresh rates of the first and third pixel areas A and C can be higher than those of the second and fourth pixel areas B and D. The pixel driving frequency of the first and third pixel areas A and C can be 120 Hz. The pixel driving frequency of the second pixel area B can be 10 Hz, and the pixel driving frequency of the fourth pixel area D can be 30 Hz. The refresh rate of each of pixel areas A, B, C, and D is not limited to FIG. 2. Each of the pixel areas A, B, C, and D can have a variable refresh rate under the control of the timing controller 130.

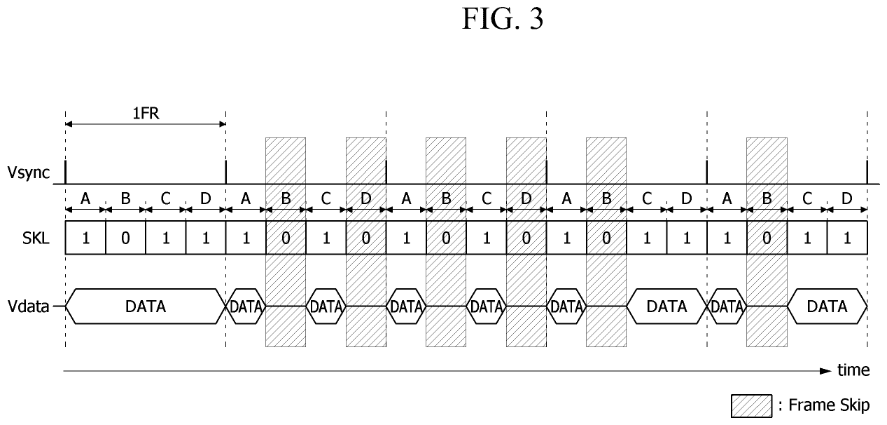

FIG. 3 is a diagram showing a multi-frequency control method of a timing controller. In FIG. 3, Vsync represents a vertical synchronization signal, SKL represents a skip logic signal generated within the timing controller 130, and Vdata represents a data voltage output from a data driver 110. 1FR is a one-frame period.

Referring to FIG. 3, the timing controller 130 can control frame skip for each pixel area. The one frame period can include one or more refresh periods during which pixel data DATA is updated for pixels, and one or more frame skip periods during which pixel data DATA is not updated for pixels. In the following, the refresh pixel area is a pixel area that is scanned by a gate signal synchronized to the data voltage during the refresh period so that the pixel data DATA is written. During the refresh period, the pixel data DATA can be updated for the pixels in the refresh pixel area during the corresponding frame period. Meanwhile, the skip pixel area is a pixel area in which the pixel data DATA is not written and the previous data voltage is maintained during the frame skip period. The pixel data DATA is not updated because pixel data is not written to pixels in the skip pixel area.

A first logic value of the skip logic signal SKP, for example, ‘1’ indicates the refresh pixel area. During the refresh period, the frame skip is deactivated, allowing pixel data to be written to the pixels normally. During the refresh period, under the control of the timing controller 130, the data driver 110 outputs the data voltage Vdata of the pixel data DATA, and the gate driver 120 outputs the gate signal.

A second logic value of the skip logic signal SKP, for example, ‘0 (zero),’ indicates the skip pixel area. During the frame skip period, the frame skip is activated allowing pixel data DATA to be not written to pixels in the pixel area selected as the skip pixel area. During the frame skip period, under the control of the timing controller 130, the data driver 110 does not output the data voltage Vdata, and the gate driver 120 does not output at least one gate signal. Therefore, during the frame skip period, the power consumption can be reduced because the pixels in the skip pixel area and the data driver are not driven, and at least one gate driver is not driven.

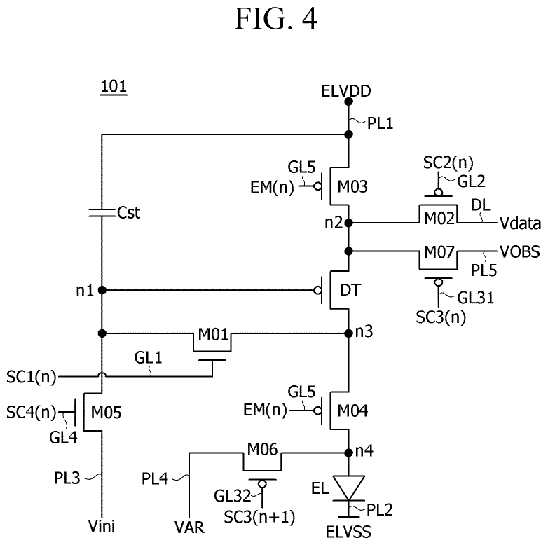

FIG. 4 is a circuit diagram showing a pixel circuit according to a first embodiment of the present disclosure. The pixel circuit illustrated in FIG. 4 can be a pixel circuit of a sub-pixel existing in the nth (n is a natural number) pixel line.

Referring to FIG. 4, a pixel circuit 101 includes a light-emitting element EL, a driving element DT for driving the light-emitting element EL, a plurality of switching elements M01 to M07, and a capacitor Cst. Each of the first and fifth switching elements M01 and M05 can be implemented as an n-channel oxide TFT having a low off-current. The off-current is a leakage current that flows through a semiconductor channel of a transistor in an off-state. Each of the driving element DT, the second element M02, the third element M03, the fourth element M04, the sixth element M06, and seventh switching element M07 can be implemented as a p-channel LTPS TFT having a high on-current.

The pixel circuit 101 is connected to a data line DL to which a data voltage Vdata of pixel data is applied, and gate lines GL1 to GL5 to which gate signals SC1 (n) to SC4 (n), and EM (n) are applied.

The pixel circuit 101 can be connected to power supply nodes to which constant voltages are applied, such as a constant voltage node PL1 to which a pixel driving voltage ELVDD is applied, a constant voltage node PL2 to which the cathode voltage ELVSS is applied, a constant voltage node PL3 to which an initialization voltage Vini is applied, a constant voltage node PL4 to which an anode reset voltage VAR is applied, and a constant voltage node PL5 to which an on-bias voltage VOBS is applied. The cathode voltage ELVSS can be a pixel ground voltage. On the display panel 100, the power lines to which the constant voltage nodes are connected can be commonly connected to all pixels.

The pixel driving voltage ELVDD and the cathode voltage ELVSS can be set to a voltage at which the driving element DT can operate in a saturation area. The pixel driving voltage ELVDD can be set to a voltage between 2V and 3V, and the cathode voltage ELVSS can be set to a voltage between −8 V and −10 V, but is not limited thereto. The gate high voltage VGH can be set to a voltage higher than the pixel driving voltage ELVDD, and the gate low voltage VGL can be set to a voltage lower than the cathode voltage ELVSS, but is not limited thereto.

The anode reset voltage VAR can be, but is not limited to, a voltage between −4 V and −8 V. The anode reset voltage VAR can initialize the anode electrode of the light-emitting element EL. The on-bias voltage VOBS can be between 4 V and 8 V, but is not limited thereto. The on-bias voltage VOBS can improve the hysteresis of the driving element DT by changing the direction of the current flowing to the driving element DT.

The initialization voltage Vini can be set to a voltage lower than the lower limit of the data voltage Vdata and higher than the cathode voltage ELVSS, but is not limited thereto. For example, when the lower limit voltage of the data voltage Vdata is 2 V and the cathode voltage ELVSS is −9 V, the initialization voltage Vinit can be set to a voltage between −5 V and −7 V. The data voltage Vdata can have a dynamic range between 2 V and 6 V. Within this dynamic range, the voltage level of the data voltage Vdata can be selected according to the grayscale value of the pixel data.

The gate signals SC1(n) to SC4(n), and EM(n) can include pulses that swing between the gate high voltage VGH and the gate low voltage VGL. The gate signals SC1(n) to SC4(n), and EM(n) can include a first scan signal SC1(n), a second scan signal SC2(n), a third scan signal SC3(n), a fourth scan signal SC4(n), and an EM signal EM(n).

The driving element DT generates a current according to the gate-source voltage Vgs to drive the light-emitting element EL. The driving element DT includes a gate electrode connected to a first node n1, a first electrode connected to a second node n2, and a second electrode connected to a third node n3.

The light-emitting element EL can be implemented as an OLED. The light-emitting element EL includes an anode electrode, a cathode electrode, and an organic compound layer interposed between these electrodes. The anode electrode of the light-emitting element EL is connected to a fourth node n4, and the cathode electrode is connected to a second constant voltage node PL2 to which a cathode voltage ELVSS is applied. The organic compound layer can include, but is not limited to, a hole injection layer (HIL), a hole transport layer (HTL), an emission layer (EML), an electron transport layer (ETL), and an electron injection layer (EIL). When a voltage is applied to the anode and cathode electrodes of the light-emitting element EL, holes passing through the hole transport layer (HTL) and electrons passing through the electron transport layer (ETL) move to the emission layer (EML) to form excitons. In this case, visible light is emitted from the emission layer (EML). The light-emitting element EL can be implemented as an OLED having a tandem structure with multiple light emitting layers stacked on top of each other. The OLED having the tandem structure can improve the luminance and lifetime of the pixels.

The capacitor Cst is connected between the first constant voltage node PL1, to which the pixel driving voltage ELVDD is applied, and the first node n1.

A first witch element M01 is connected between the second node n1 and the third node n3. The first switching element M01 can be turned on in response to the gate high voltage VGH of the first gate signal SC1(n). When the first switching element M01 is turned on, the first node n1 is electrically connected to the third node n3. The first switching element M01 includes a gate electrode connected to a first gate line GL1 to which the first gate signal SC1(n) is applied, a first electrode connected to the first node n1, and a second electrode connected to a third node n3.

A second switching element M02 is connected between the data line DL and the second node n2. The second switching element M02 can be turned on in response to the gate low voltage VGL of the second gate signal SC2(n). When the second switching element M02 is turned on, the data line DL to which the data voltage Vdata of the pixel data is applied is electrically connected to the second node n2, so that the data voltage Vdata is applied to the second node n2. The second switching element M02 includes a gate electrode connected to a second gate line GL2 to which the second gate signal SC2(n) is applied, a first electrode connected to the data line DL, and a second electrode connected to the second node n2.

The third switching element M03 is connected between the first constant voltage node PL1 to which the pixel driving voltage ELVDD is applied and the second node n2. The third switching element M03 can be turned on in response to the gate low voltage VGL of the fifth gate signal EM(n). When the third switching element M03 is turned on, the first constant voltage node PL1 is electrically connected to the second node n2. The third switching element M03 includes a gate electrode connected to a fifth gate line GL5 to which the fifth gate signal EM(n) is applied, a first electrode connected to the first constant voltage node PL1, and a second electrode connected to the second node n2.

A four switching element M04 is connected between the third node n3 and the fourth node n4. The fourth switching element M04 can be turned on in response to the gate low voltage VGL of the fifth gate signal EM(n). When the fourth switching element M04 is turned on, the third node n3 is electrically connected to the fourth node n4. The fourth switching element M04 includes a gate electrode connected to the fifth gate line GL5, a first electrode connected to the third node n3, and a second electrode connected to the fourth node n4.

A fifth switching element M05 is connected between the first node n1 and a third constant voltage node PL3 to which the initialization voltage Vini is applied. The fifth switching element M05 can be turned on in response to the gate high voltage VGH of the fourth gate signal SC4(n). When the fifth switching element M05 is turned on, the first node n1 is electrically connected to the third constant voltage node PL3. The fifth switching element M05 includes a gate electrode connected to a fourth gate line GL4 to which a fourth gate signal SC4(n) is applied, a first electrode connected to a first node n1, and a second electrode connected to a third constant voltage node PL3.

A sixth switching element M06 is connected between the fourth node n4 and a fourth constant voltage node PL4 to which the anode reset voltage VAR is applied. The sixth switching element M06 can be turned on in response to the gate low voltage VGL of a third-second gate signal SC3(n+1). When the sixth switching element M06 is turned on, the fourth node n4 is electrically connected to the fourth constant voltage node PL4 and the anode reset voltage VAR is applied to the fourth node n4. The sixth switching element M06 includes a gate electrode connected to a third-second gate line GL32 to which the third-second gate signal SC3(n+1) is applied, a first electrode connected to the fourth node n4, and a second electrode connected to the fourth constant voltage node PL4.

A seventh switching element M07 is connected between the second node n2 and a fifth constant voltage node PL5 to which the on-bias voltage VOBS is applied. The seventh switching element M07 can be turned on in response to the gate low voltage VGL of a third-first gate signal SC3(n). When the seventh switching element M07 is turned on, the second node n2 is electrically connected to the fifth constant voltage node PL5 to which the on-bias voltage VOBS is applied, and the on-bias voltage VOBS is applied to the second node n2. The seventh switching element M07 includes a gate electrode connected to a third-first gate line GL31 to which the third-first gate signal SC3(n) is applied, a first electrode connected to the second node n2, and a second electrode connected to the fifth constant voltage node PL5.

The pulses of the third-first gate signal SC3(n) and the third-second gate signal SC3(n+1) are sequentially generated with the gate low voltage VGL. The pulse of the third-first gate signal SC3(n) is applied to the gate electrode of the sixth switching element M06 in the pixels of the n-th pixel line and simultaneously applied to the gate electrode of the seventh switching element M07 in the pixels of the n−1th pixel line. Subsequently, the pulse of the third-second gate signal SC3(n+1) is applied to the gate electrode of the seventh switching element M07 in the pixels of the n-th pixel line and simultaneously applied to the gate electrode of the sixth switching element M06 in the pixels of the n-th pixel line. Accordingly, in each of the pixel lines, the seventh switching element M07 can be turned on after the sixth switching element M06 in the pixel circuit 101 is turned on.

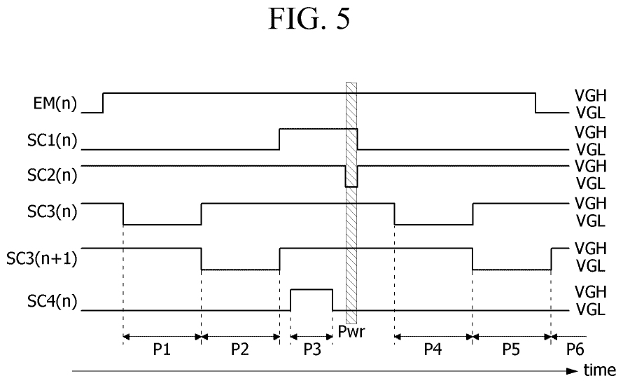

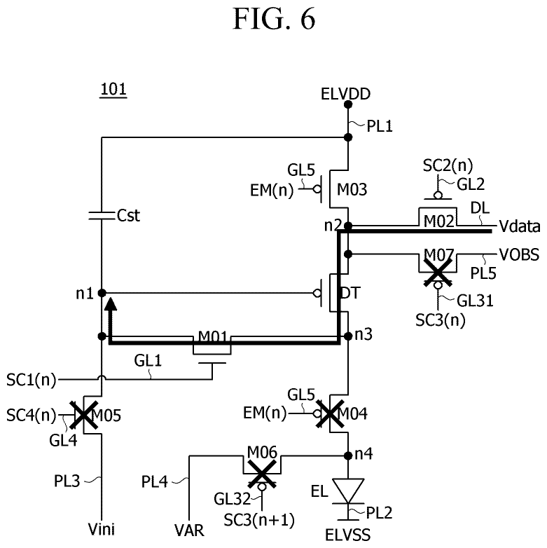

FIG. 5 is a waveform diagram showing an example of gate signals applied to the pixel circuit illustrated in FIG. 4 during a refresh period. FIG. 6 is a circuit diagram showing transistors turned on/off in a data write step during the refresh period.

Referring to FIGS. 5 and 6, the pixel circuit 101 can be driven during a refresh period in the following order: a first initialization step P1, a second initialization step P2, a sampling step P3 in which a threshold voltage of a driving element DT is sampled in a capacitor Cst, a data write step Pwr in which pixel data is written, a third initialization step P4, a fourth initialization step P5, and a light emitting step P6 in which a light-emitting element EL is driven by a current from the driving element DT.

In the first and third initialization steps P1 and P4, an initialization voltage Vini is applied to the first and third nodes n1 and n2, and the on-bias voltage VOBS is applied to the second node n2. In the second and fourth initialization steps P2 and P5, the anode reset voltage VAR is applied to the fourth node n4.

The data write step can be interpreted as a programming step. In the data write step Pwr, as shown in FIG. 6, the first and second switching elements M01 and M02 are turned on in response to the gate-on voltage, while the third to seventh switching elements M03, M04, M05, M06, and M07 are turned off in response to the gate-off voltage. In the data write step Pwr, as shown in FIG. 6, the data voltage Vdata of the pixel data is applied to the first node n1 via the first and second switching elements M01 and M02 and charged to the capacitor Cst. As a result, the pixel data input in the current frame period can be written to the pixel circuit 101 of the sub-pixel corresponding to the refresh period. In FIG. 5, ‘X’ represents a transistor in the off state.

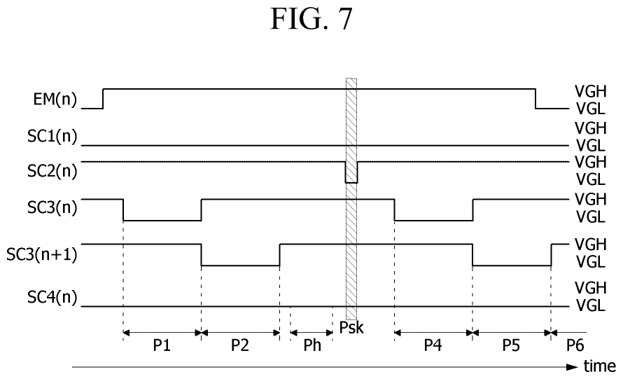

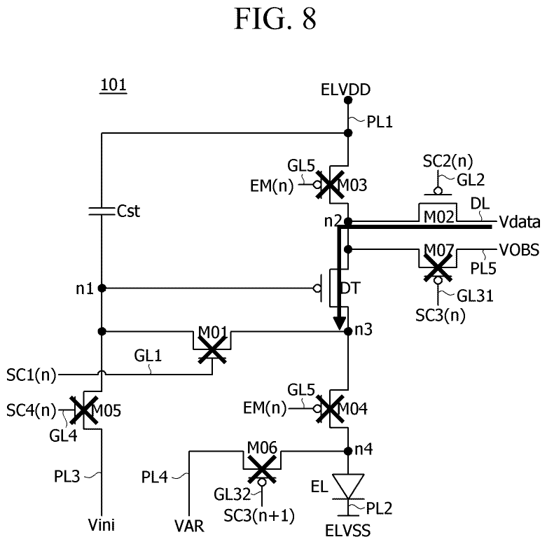

FIG. 7 is a waveform diagram showing an example of gate signals applied to the pixel circuit 101 illustrated in FIG. 4 during a frame skip period. FIG. 8 is a circuit diagram showing transistors turned on/off during a data skip step.

Referring to FIGS. 7 and 8, the pixel circuit 101 can be driven during a frame skip period in the following order: a first initialization step P1, a second initialization step P2, a hold step Ph, a data skip step Psk, a third initialization step P4, a fourth initialization step P5, and a light emitting step P6. The hold step Ph corresponds to the sampling step Psam of the refresh period when viewed on the time axis. The data skip step Psk corresponds to the data write step Pwr of the refresh period when viewed on the time axis.

In the hold step Ph, the switching elements M01 to M07 are turned off because the voltages of the gate signals SC1(n), SC2(n), SC3(n), SC3(n+1), and EM(n) are gate-off voltages. Therefore, in the hold step Ph, the first to fourth nodes n1 to n4 are floated, so that the voltages of the nodes n1 to n4 are maintained at the voltages at the end of the second initialization step P2, and thus the voltage of the capacitor Cst are not changed.

In the data skip step Psk, the second switching element M02 is turned on in response to the gate-on voltage, whereas the first switching element M01 and the third to seventh switching elements M03, M04, M05, M06, and M07 are turned off in response to the gate-off voltage. In the data skip step Psk, since the first and fifth switching elements M01 and M05 are turned off, the data voltage Vdata of the pixel data is not applied to the first node n1, and the first node n1 is floated and is not discharged. Therefore, during the frame skip period, the voltage of the first node n1, for example, the data voltage Vdata charged in the capacitor Cst, is hardly discharged and can be maintained until the next frame period.

As shown in FIGS. 5 and 7, the pixel circuit 101 illustrated in FIG. 4 can operate as a sub-pixel of a refresh pixel area or can operate as a sub-pixel of a skip pixel area, depending on the voltage levels of the gate signals, particularly the first and fourth gate signals SC1(n) and SC4(n). In the data skip period Psk of the frame skip period corresponding to the data writing period Pwr, when the voltages of the first and fourth gate signals SC1(n) and SC4(n) are the gate low voltage VGL, which is the gate off voltage, the pixel circuit 101 operates as a sub-pixel of the skip pixel area.

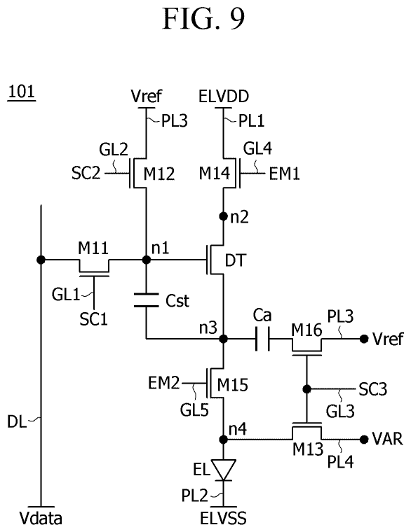

FIG. 9 is a circuit diagram showing a pixel circuit according to a second embodiment of the present disclosure. In FIG. 9, a description overlapping with the above-described first embodiment can be omitted or briefly discussed.

Referring to FIG. 9, the pixel circuit 101 includes a light-emitting element EL, a driving element DT for driving the light-emitting element EL, a plurality of switching elements M11 to M16, a first capacitor Cst, and a second capacitor Ca. Each of the driving element DT and the switching elements M11 to M16 can be implemented as an n-channel oxide TFT, but is not limited thereto.

The driving element DT includes a gate electrode connected to a first node n1, a first electrode connected to a second node n2, and a second electrode connected to a third node n3. An anode electrode of the light-emitting element EL is connected to a fourth node n4. A cathode voltage ELVSS is applied to a cathode electrode of the light-emitting element EL.

The first capacitor Cst is connected between the first node n1 and the third node n3. The second capacitor Ca is connected between the third node n3 and the first electrode of the sixth switching element M16.

The first switching element M11 is connected between the first node n1 and the data line DL to which a data voltage Vdata is applied. The first switching element M11 can be turned on in response to a gate high voltage VGH of the first gate signal SC1. When the first switching element M11 is turned on, the first node n1 is electrically connected to the data line DL and the data voltage Vdata is applied to the first node n1. The first switching element M11 includes a gate electrode connected to a first gate line GL1 to which the first gate signal SC1 is applied, a first electrode connected to the first node n1, and a second electrode connected to the data line DL.

The second switching element M12 is connected between the fourth node n1 and a third constant voltage node PL3 to which a reference voltage Vref is applied. The second switching element M12 can be turned on in response to the gate high voltage VGH of a second gate signal SC2. When the second switching element M12 is turned on, the first node n1 is electrically connected to the third constant voltage node PL3 and the reference voltage Vref is applied to the first node n1. The second switching element M12 includes a gate electrode connected to a second gate line GL2 to which the second gate signal SC2 is applied, a first electrode connected to the third constant voltage node PL3, and a second electrode connected to the first node n1.

The third switching element M13 is connected between the fourth node n4 and a fourth constant voltage node PL4 to which an anode reset voltage VAR is applied. The third switching element M13 can be turned on in response to the gate high voltage VGH of a third gate signal SC3. When the third switching element M13 is turned on, the fourth node n4 is electrically connected to the fourth constant voltage node PL4. The third switching element M13 includes a gate electrode connected to the third gate line GL3 to which the third gate signal SC3 is applied, a first electrode connected to the fourth node n4, and a second electrode connected to the fourth constant voltage node PL4.

The fourth switching element M14 is connected between a first constant voltage node PL1 to which a pixel driving voltage ELVDD is applied and the second node n2. The fourth switching element M14 can be turned on in response to the gate high voltage VGH of the fourth gate signal EM1. When the fourth switching element M14 is turned on, the first constant voltage node PL1 is electrically connected to the second node n2. The fourth switching element M14 includes a gate electrode connected to the fourth gate line GL4 to which the fourth gate signal EM1 is applied, a first electrode connected to the first constant voltage node PL1, and a second electrode connected to the second node n2.

The fifth switching element M15 is connected between the third node n3 and the fourth node n4. The fifth switching element M15 can be turned on in response to the gate high voltage VGH of the fifth gate signal EM2. When the fifth switching element M15 is turned on, the third node n3 is electrically connected to the fourth node n4. The fifth switching element M15 includes a gate electrode connected to the first gate line GL5 to which the first gate signal EM2 is applied, a first electrode connected to the third node n3, and a second electrode connected to the fourth node n4.

The sixth switching element M16 is connected between the third node n3 and the third constant voltage node PL3 to which the reference voltage Vref is applied. The sixth switching element M16 can be turned on in response to the gate high voltage VGH of the third gate signal SC3. When the sixth switching element M16 is turned on, the third node n3 is electrically connected to the third constant voltage node PL3. The sixth switching element M16 includes a gate electrode to which the third gate signal SC3 is applied, a first electrode connected to the third node n3, and a second electrode to which the reference voltage Vref is applied.

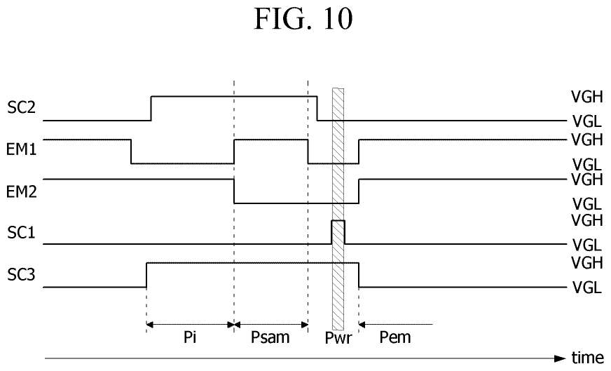

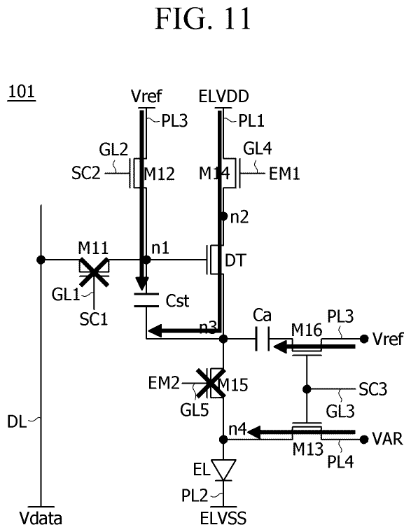

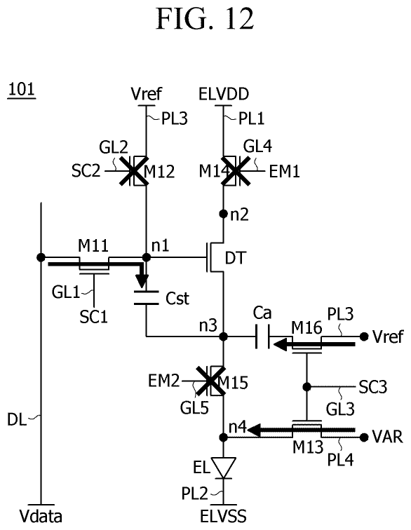

FIG. 10 is a waveform diagram showing an example of gate signals applied to a pixel circuit illustrated in FIG. 9 during a refresh period. FIG. 11 is a circuit diagram showing transistors turned on/off in a sampling step during the refresh period. FIG. 12 is a circuit diagram showing transistors turned on/off in a data write step during the refresh period. In FIGS. 11 and 12, ‘X’ represents a transistor in the off state.

Referring to FIGS. 9 and 10, the pixel circuit 101 can be driven in the following order: an initialization step Pi in which the pixel circuit 101 is initialized during a refresh period, a sampling step Psam in which a threshold voltage of the driving element DT is sampled, a data write step Pwr in which pixel data is written, and a light emitting step Pem in which the light-emitting element EL is driven.

In the sampling step Psam of the refresh period, the second, third, fourth, and sixth switching elements M12, M13, M14, and M16 are turned on, while the first and fifth switching elements M11, M15 are turned off, as shown in FIG. 11. In the sampling step Psam, a reference voltage Vref is applied to the first node n1, and ELVDD−Vth is applied to the third node n3. Here, ‘Vth’ is the threshold voltage of the driving element DT. Therefore, in the sampling step Psam of the refresh period, the voltage Vref−(VDD−Vth) reflecting the threshold voltage Vth of the driving element DT is sampled and stored in the first capacitor Cst.

In the data write step Pwr of the refresh period, the first, third, and sixth switching elements M11, M13, and M16 are turned on, while the second, fourth, and fifth switching elements M12, M14, and M15 are turned off, as shown in FIG. 12. In the data write step Pwr, the data voltage Vdata of the pixel data is applied to the first node n1 via the first switching element M11 and charged to the capacitor Cst. In this case, the voltage of the third node n3 is ELVDD−Vth+a, where ‘a’ is Vdata−Vref.

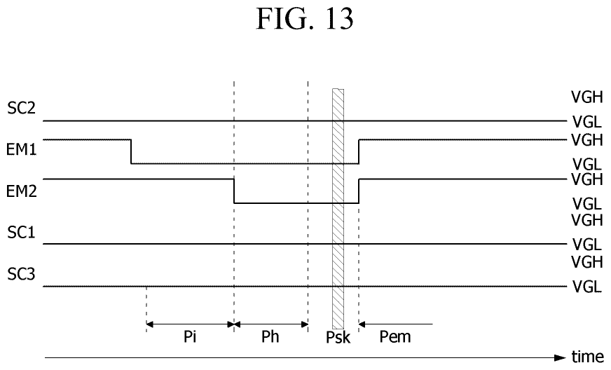

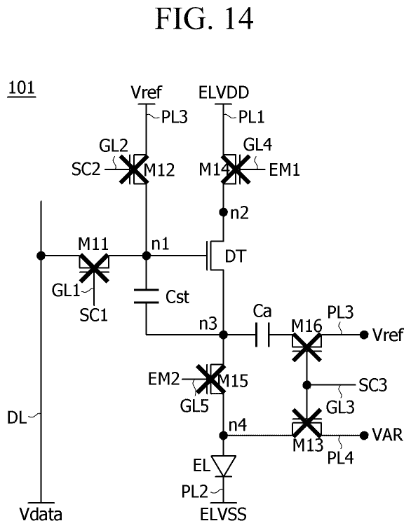

FIG. 13 is a waveform diagram showing an example of gate signals applied to the pixel circuit illustrated in FIG. 9 during a frame skip period. FIG. 14 is a circuit diagram showing transistors of an off state in a hold step and a data skip step during the frame skip period.

Referring to FIGS. 13 and 14, the pixel circuit 101 can be driven in the following order: an initialization step Pi, a hold step Ph, a data skip step Psk, and a light emission step Pem during a frame skip period. The hold step Ph corresponds to the sampling step Psam of the refresh period when viewed on the time axis. The data skip step Psk corresponds to the data write step Pwr of the refresh period when viewed on the time axis.

The initialization step Pi, the hold step Ph, and the data skip step Psk of the frame skip period are controlled differently from the initialization step Pi, the sampling step Psam, and the data write step Pwr of the refresh period by setting the voltages of the gate signals differently.

In the initialization step Pi of the frame skip period, the voltages of the first to fourth gate signals SC1, SC2, SC3, and EM1 are gate low voltages VGL, which are gate-off voltages. As a result, in the initialization step Pi, the first, second, third, fourth, and sixth switching elements M11, M12, M13, M14, and M16 are turned off, so that the first to fourth nodes n1 to n4 are floated so that the voltages of the nodes n1 to n4 and the voltages of the capacitors Cst and Ca are not changed.

In the hold step Ph and the data skip step Psk of the frame skip period, the voltages of the gate signals SC1, SC2, SC3, EM1 and EM2 are gate low voltages VGL, which are gate off voltages. Therefore, in the hold step Ph, as shown in FIG. 14, the switching elements M11 to M14 are turned off, so that the first to fourth nodes n1 to n4 are floated and maintained at the voltage set in the initialization step. In this case, the voltage of the capacitors Cst and Ca are not changed.

As illustrated in FIGS. 10 and 13, the pixel circuit 101 illustrated in FIG. 9 can operate as a sub-pixel of a refresh pixel area or can operate as a sub-pixel of a skip pixel area, depending on the voltage levels of the gate signals, particularly the first, second, third, and fourth gate signals SC1, SC2, SC3, and EM1. When the voltages of the first, second, third and fourth gate signals SC1, SC2, SC3, and EM1 are controlled by the gate-off voltage during the hold period (hold step) Ph and the data skip period (data skip step) Psk of the frame skip period, the pixel circuit 101 operates as a sub-pixel of the skip pixel area.

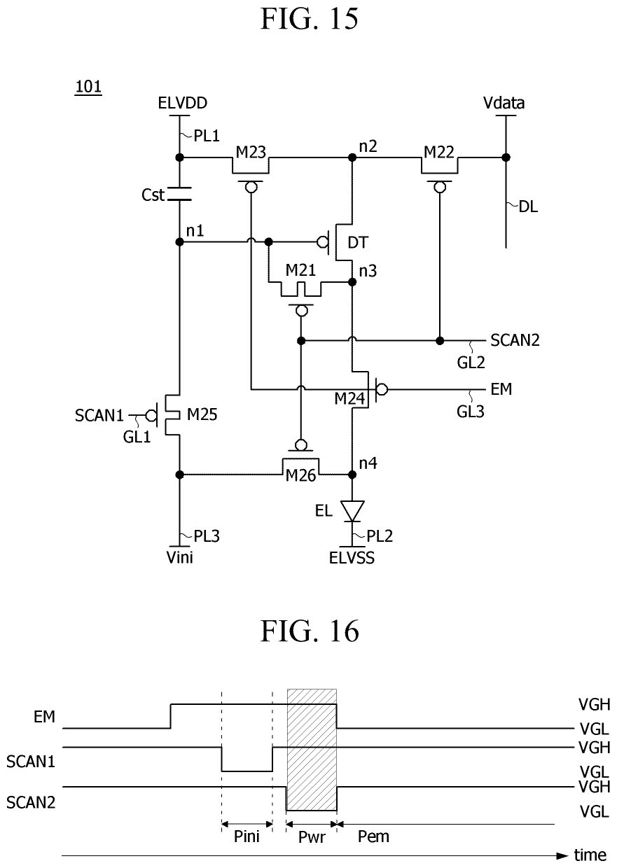

FIG. 15 is a circuit diagram showing a pixel circuit according to a third embodiment of the present disclosure. In FIG. 15, a description overlapping with the above-described embodiments can be omitted or briefly discussed.

Referring to FIG. 15, the pixel circuit 101 includes a light-emitting element EL, a driving element DT for driving the light-emitting element EL, a plurality of switching elements M21 to M26, and a capacitor Cst. Each of the driving elements DT and the switching elements M21 to M26 can be implemented as a p-channel LTPS TFT, but is not limited thereto.

The driving element DT includes a gate electrode connected to the first node n1, a first electrode connected to the second node n2, and a second electrode connected to a third node n3. An anode electrode of the light-emitting element EL is connected to a fourth node n4. A cathode voltage ELVSS is applied to a cathode electrode of the light-emitting element EL. The capacitor Cst is connected between the first node n1 and a first constant voltage node PL1 to which the pixel driving voltage ELVDD is applied.

A first witch element M21 is connected between the second node n1 and the third node n3. The first switching element M21 can be turned on in response to the gate low voltage VGL of the second gate signal SCAN2. When the first switching element M21 is turned on, the first node n1 is electrically connected to the third node n3. The first switching element M21 includes a gate electrode connected to the second gate line GL2 to which the second gate signal SCAN2 is applied, a first electrode connected to the first node n1, and a second electrode connected to the third node n3.

The pulses of the first and second gate signals SCAN1 and SCAN2 are generated as the gate low voltage VGL. Following the pulse of the first gate signal SCAN1, the pulse of the second gate signal SCAN2 is input to the pixel circuit 101.

The second switching element M22 is connected between the second node n2 and the data line DL to which the data voltage Vdata is applied. The second switching element M22 can be turned on in response to the gate low voltage VGL of the second gate signal SCAN2. When the second switching element M22 is turned on, the second node n2 is electrically connected to the data line DL and the data voltage Vdata is applied to the second node n2. The second switching element M22 includes a gate electrode to which the second gate signal SCAN2 is applied, a first electrode connected to the second node n2, and a second electrode connected to the data line DL.

The third switching element M23 is connected between the first constant voltage node PL1 to which the pixel driving voltage ELVDD is applied and the second node n2. The third switching element M23 can be turned on in response to the gate low voltage VGL of the third gate signal EM. When the third switching element M23 is turned on, the first constant voltage node PL1 is electrically connected to the second node n2. The third switching element M23 includes a gate electrode connected to the third gate line GL3 to which the third gate signal EM is applied, a first electrode connected to the first constant voltage node PL1, and a second electrode connected to the second node n2.

The four switching element M24 is connected between the third node n3 and the fourth node n4. The fourth switching element M24 can be turned on in response to the gate low voltage VGL of the third gate signal EM. When the fourth switching element M24 is turned on, the third node n3 is electrically connected to the fourth node n4. The fourth switching element M24 includes a gate electrode connected to the third gate line GL3 to which the third gate signal EM is applied, a first electrode connected to the third node n3, and a second electrode connected to the fourth node n4.

The fifth switching element M25 is connected between the first node n1 and a third constant voltage node PL3 to which the initialization voltage Vini is applied. The fifth switching element M25 can be turned on in response to the gate low voltage VGL of the first gate signal SCAN1. When the fifth switching element M25 is turned on, the first node n1 is electrically connected to the third constant voltage node PL3. The fifth switching element M25 includes a gate electrode to which the first gate signal SCAN1 is applied, a first electrode connected to the first node n1, and a second electrode to which the reference voltage Vref is applied.

The fifth switching element M26 is connected between the fourth node n4 and the third constant voltage node PL3. The sixth switching element M26 can be turned on in response to the gate low voltage VGL of the second gate signal SCAN2. When the sixth switching element M26 is turned on, the fourth node n4 is electrically connected to the third constant voltage node PL3. The sixth switching element M26 includes a gate electrode connected to the second gate line GL2 to which the second gate signal SCAN2 is applied, a first electrode connected to the fourth node n4, and a second electrode connected to the third constant voltage node PL3.

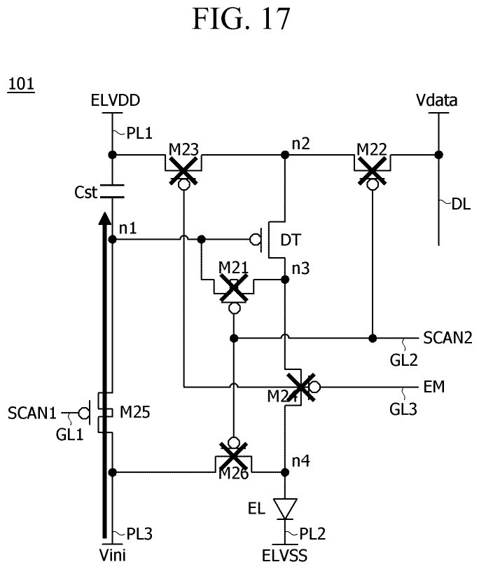

The first and fifth switching elements M21 and M25 are susceptible to leakage current due to their long off period. In view of this, the first and fifth switching elements M21 and M25 can be transistors of a dual gate structure with a low leakage current, as illustrated in FIG. 15, but are not limited thereto. For example, the first and fifth switching elements M21 and M25 may be p-channel LTPS TFTs of a dual gate structure with a low leakage current, FIG. 16 is a waveform diagram showing an example of gate signals applied to a pixel circuit illustrated in FIG. 15 during a refresh period. FIG. 17 is a circuit diagram showing transistors turned on/off in an initialization step during the refresh period. FIG. 18 is a circuit diagram showing transistors turned on/off in a data write step during the refresh period. In FIGS. 17 and 18, ‘X’ represents a transistor in the off state.

Referring to FIGS. 16 and 17, the pixel circuit 101 can be driven during a refresh period in the following order: an initialization step Pini in which the pixel circuit 101 is initialized, a data write step Pwr in which the threshold voltage of the driving element DT is sampled and pixel data is written, and a light emitting step Pem in which the light-emitting element EL is driven.

In the initialization step Pini of the refresh period, the voltage of the first gate signal SCAN1 is the gate low voltage VGL, while the voltages of the second and third gate signals SCAN2 and EN are the gate high voltage VGH. Therefore, in the initialization step Pini, as shown in FIG. 17, the fifth switching element M25 is turned on, other switching elements M21, M22, M23, M24, and M26 are turned off, and the initialization voltage Vini is applied to the first node n1.

In the data write step Pwr of the refresh period, the voltage of the second gate signal SCAN2 is the gate low voltage VGL, while the voltages of the first and third gate signals SCAN1, and EN are the gate high voltage VGH. Therefore, in the data write step Pwr, the first, second, and sixth switching elements M21, M22, and M26 are turned on, while the third, fourth, and fifth switching elements M23, M24, and M25 are turned off, as shown in FIG. 18. In the data write step Pwr, the data voltage Vdata of the pixel data is applied to the first node n1 via the first and second switching elements M21 and M22, and the initialization voltage Vini is applied to the fourth node n4.

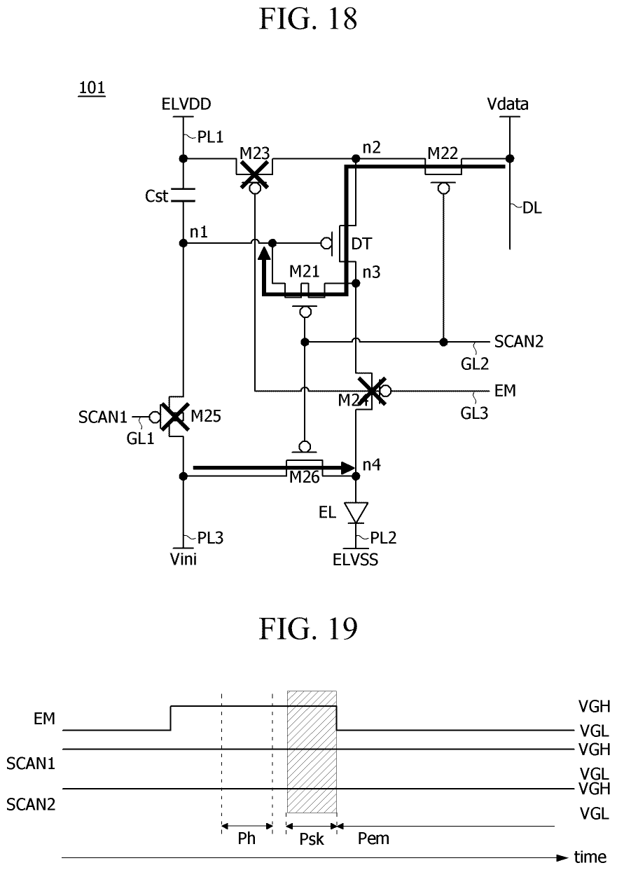

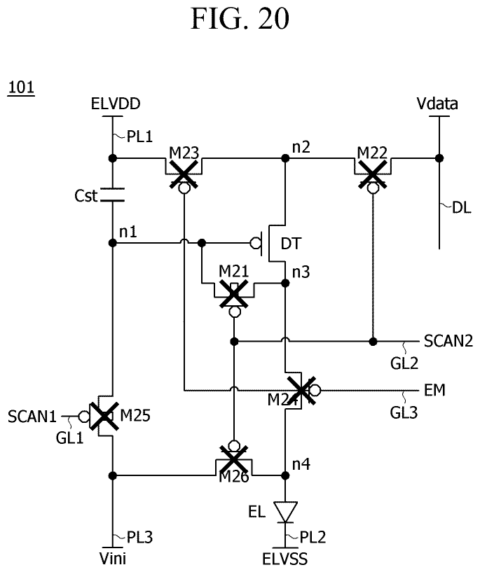

FIG. 19 is a waveform diagram showing an example of gate signals applied to the pixel circuit 101 illustrated in FIG. 15 during a frame skip period. FIG. 20 is a circuit diagram showing transistors in the off state in a hold step and a data skip step during the frame skip period.

Referring to FIGS. 19 and 20, the pixel circuit 101 can be driven in a data skip step Psk following the hold step Ph during the frame skip period. The hold step Ph corresponds to the initialization step Pini of the refresh period when viewed on the time axis. The data skip step Psk corresponds to the data write step Pwr of the refresh period when viewed on the time axis.

The hold step Ph and data skip step Psk of the frame skip period are controlled differently from the initialization step Pini and data write step Pwr of the refresh period by setting the voltages of the first and second gate signals SCAN1 and SCAN2 differently.

In the hold step Ph and data skip step Psk of the frame skip period, the voltages of the gate signals SCAN1, SCAN2, and EM are the gate high voltage VGH, which is the gate off voltage. As a result, in the hold step Ph and the data skip step Psk, all the switching elements M21 to M26 are turned off so that the first to fourth nodes n1 to n4 are floated, and the voltages of the nodes n1 to n4 and the voltage of the capacitor Cst are not changed.

As shown in FIG. 16 and FIG. 19, the pixel circuit 101 illustrated in FIG. 15 can operate as a sub-pixel of a refresh pixel area or can operate as a sub-pixel of a skip pixel area, depending on the voltage levels of the gate signals, particularly the first and second gate signals SCAN1 and SCAN2. In the hold period Ph and the data skip period Psk of the frame skip period, when the voltages of the first and second gate signals SCAN1 and SCAN2 are controlled by the gate-off voltage, the pixel circuit 101 operates as a sub-pixel of the skip pixel area.

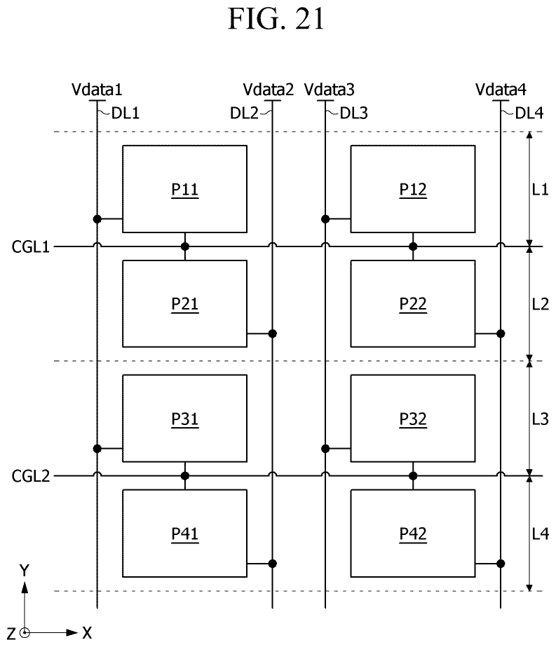

In a display panel 100 according to an embodiment of the present disclosure, sub-pixels can be connected to data lines and gate lines in a structure as shown in FIG. 21. As shown in FIG. 21, subpixels P11, P12, P21, P22, P31, P32, P41, and P42 are provided in the areas where data lines DL1, DL2, DL3, and DL4 intersect with gate lines CGL1 and CGL2. However, the arrangements of the data lines and the gate lines, and the subpixels are not limited thereto. The structure of the display panel such as FIG. 21 is advantageous to secure the threshold voltage sampling time of the driving element DT when sub-pixels are driven at high speed in a high resolution display panel.

Referring to FIG. 21, at least one of the gate lines arranged on the display panel can be branched into two gate lines and commonly connected to sub-pixels of different pixel lines.

For example, the sub-pixels P11, P12, P31, and P32 located on odd-numbered pixel lines L1 and L3 can be connected to odd-numbered data lines DL1 and DL3 close to them to receive data voltages Vdata1 and Vdata3 via the odd-numbered data lines DL1 and DL3. In contrast, the sub-pixels P21, P22, P41, and P42 located on even-numbered pixel lines L2 and L4 can be connected to even-numbered data lines DL2 and DL4 close to them to receive data voltages Vdata2 and Vdata4 via the even-numbered data lines DL2 and DL4.

The sub-pixels located on the adjacent pixel lines share the same common gate signal. For example, the sub-pixels P11, P12, P21, and P22 located on the first pixel line L1 and the second pixel line L2 are connected to a first common gate line CGL1 to receive a first common gate signal. The sub-pixels P31, P32, P41, and P42 located on the third pixel line L3 and the fourth pixel line L4 are connected to a second common gate line CGL2 to receive a second common gate signal. Therefore, since the sub-pixels located on the adjacent neighboring pixel lines are simultaneously driven and charged with different data voltages Vdata1 to Vdata4, the sampling time required to sense the threshold voltage of the driving element DT can be sufficiently secured. For example, when two adjacent pixel lines are simultaneously driven, the sampling time can be secured as two horizontal periods.

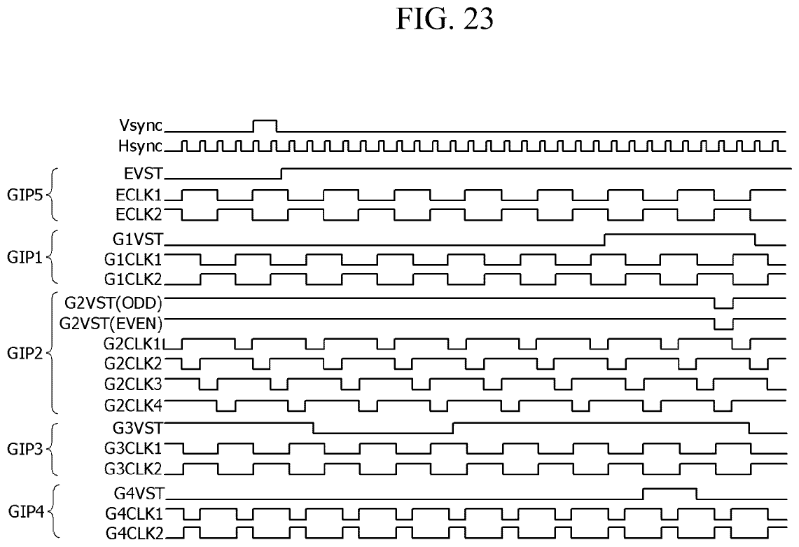

FIG. 22 is a diagram showing first to fourth gate drivers for driving the pixel circuit illustrated in FIG. 4. FIG. 23 is a waveform diagram showing clocks and start pulses input to the gate drivers illustrated in FIG. 22.

Referring to FIGS. 4, 22, and 23, the gate driver 120 can include a first gate driver GIP1 that sequentially outputs pulses of first gate signals SC1(n−1), SC1(n), and SC1(n+1), a second gate driver GIP2 that sequentially outputs pulses of second gate signals SC21 to SC26, a third gate driver GIP3 that sequentially outputs pulses of third gate signals SC3(n−1), SC3(n), and SC3(n+1), a fourth gate driver GIP4 that sequentially outputs pulses of fourth gate signals SC4(n−1), SC4(n), and SC4(n+1), and a fifth gate driver GIP5 that outputs pulses of fifth gate signals EM(n−1), EM(n), and EM(n+1). The second gate driver GIP2 can be implemented as a shift register, and the other gate drivers GIP1, GIP3, GIP4, and GIP5 can be implemented as edge triggers, but are not limited thereto.

Each of the first, third, fourth, and fifth gate drivers GIP1, GIP3, GIP4, and GIP5 can receive a start pulse and two-phase shift clocks with different phases. The two-phase shift clocks can be out of phase with each other. The pulse and phase of the gate signal can be controlled depending to the start pulse and the clocks. The first gate driver GIP1 includes a plurality of signal transmitters 310 that are cascaded connected to each other. The first gate driver GIP1 receives a start pulse G1VST and clocks G1CLK1 and G1CLK2 and sequentially outputs pulses of the first gate signals SC1(n−1), SC1(n), and SC1(n+1). The third gate driver GIP3 includes a plurality of signal transmitters 330 that are cascaded connected to each other. The third gate driver GIP3 receives a start pulse G3VST and clocks G3CLK1 and G3CLK2) and sequentially outputs pulses of the third gate signals SC3(n−1) and SC3(n), and SC3(n+1). The fourth gate driver GIP4 includes a plurality of signal transmitters 340 that are cascaded connected to each other. The fourth gate driver GIP4 receives a start pulse G4VST and clocks G4CLK1 and G4CLK2 and sequentially outputs pulses of the fourth gate signals SC4(n−1), SC4(n), and SC4(n+1).

The second gate driver GIP2 receives first and second start pulses G2VST(ODD) and G2VST(EVEN) and a four-phase shift clocks G2CLK1 to G2CLK4. The second gate driver GIP2 includes a plurality of signal transmitters 321 that are cascaded connected to each other and sequentially output pulses of second gate signals SC21, SC23, and SC25 to be supplied to sub-pixels PXL1, PXL3, and PXL5 of the odd-numbered pixel line by receiving the first start pulse G2VST(ODD) and the clocks G2CLK1 and G2CLK2. In addition, the second gate driver GIP2 further includes a plurality of signal transmitters 322 that are cascaded connected to each other, and sequentially output pulses of second gate signals SC22, SC24, and SC26 to be supplied to sub-pixels PXL2, PXL4, and PXL6 of the even-numbered pixel line by receiving the second start pulse G2VST(EVEN) and the clocks G2CLK3 and G2CLK4.

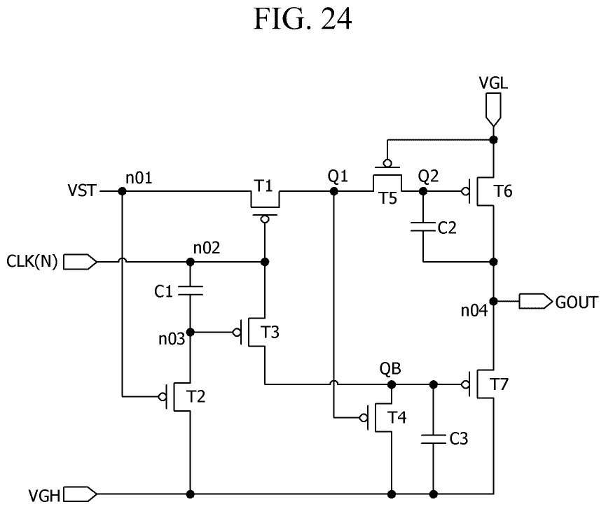

FIG. 24 is a circuit diagram showing a signal transmitter circuit of a gate driver according to one embodiment of the present disclosure. The signal transmission circuit of this gate driver can be used as a circuit that outputs a gate signal for driving the above-described pixel circuits, but the gate driving circuit of the present disclosure is not limited to the circuit illustrated in FIG. 24.

Referring to FIG. 24, the signal transmitter includes first to seventh transistors T1 to T7. Active layers of the transistors TFTs may be formed of a semiconductor material, such as polycrystalline semiconductor, but is not limited thereto. The polycrystalline semiconductor material has a fast movement speed of carriers such as electrons and holes and thus has high mobility, and has low energy power consumption and superior reliability. The polycrystalline semiconductor may be made of polycrystalline silicon (poly-Si), but is not limited thereto. For example, the transistors T1 to T7 can be, but are not limited to, p-channel LTPS TFTs. This signal transmitter can operate as an edge trigger in which a voltage equal to a voltage of a first input node n01 is output as an output voltage when the clock CLK(N) is lowered to the gate low voltage VGL.

The first transistor T1 is connected between the first input node n01 and a first-first control node Q1. The start pulse VST or a pulse of a carry signal from a previous signal transmitter is input to the first input node n01. The first transistor T1 can be turned on in response to a gate-on voltage, for example, a gate low voltage VGL, of a clock CLK(N) input to the second input node n02. When the first transistor T1 is turned on, the first input node n01 is electrically connected to the first-first control node Q1. The first transistor T1 includes a gate electrode connected to a second input node n02 to which the clock CLK(N) is input, a first electrode connected to the first input node n01, and a second electrode connected to the first-first control node Q1.

The second transistor T2 is connected between a buffer node n03 and a VGH node. A gate-off voltage, for example, a gate high voltage VGH, is applied to the VGH node. The second transistor T2 is turned on when the voltage of the first input node n01 is the gate low voltage VGL to electrically connect the buffer node n03 to the VGH node. The second transistor T2 includes a gate electrode connected to the first input node n01, a first electrode connected to the buffer node n03, and a second electrode connected to the VGH node.

The third transistor T3 is connected between the second input node n02 and a second control node QB. The third transistor T3 is turned on when the voltage of the buffer node n03 is the gate low voltage VGL to electrically connect the second input node n02 to the second control node QB. The third transistor T3 includes a gate electrode connected to the buffer node n03, a first electrode connected to the second input node n02, and a second electrode connected to the second control node QB.

A first capacitor C1 is connected between the second input node n02 and the buffer node n03. If the first capacitor C1 is not present, when the voltage of the first input node n01 is the gate low voltage VGL, the second input node n02 to which the clock CLK(N) is input can be short-circuited to the VGH node, which can cause a malfunction.

The fourth transistor T4 is connected between the second control node QB and the VGH node. The fourth transistor T4 is turned on when the voltage of the first-first control node Q1 is the gate low voltage VGL to electrically connect the second control node QB to the VGH node. The fourth transistor T4 controls the voltage of the second control node QB to be opposite to the voltages of the first-first and first-second control nodes Q1 and Q2. For example, when the voltage of the first-first control node Q1 is the gate low voltage VGL, the fourth transistor T4 can be turned on so that the second control node Q2 can be charged to the gate high voltage VGH. The fourth transistor T4 includes a gate electrode connected to the first-first control node Q1, a first electrode connected to the second control node QB, and a second electrode connected to the VGH node.

The fifth transistor T5 includes a gate electrode connected to the VGL node, a first electrode connected to the first-first control node Q1, and a second electrode connected to the first-second control node Q2.

The sixth transistor T6 is turned on when the voltage of the first-second control node Q2 is the gate low voltage VGL and electrically connects the VGL node to the output node n04. The sixth transistor T6 includes a gate electrode connected to the first-second control node Q2, a first electrode connected to the VGL node, and a second electrode connected to the output node n04. A second capacitor C2 is connected between a Q node and the output node.

The seventh transistor T7 is turned on when the voltage of the second control node QB is the gate low voltage VGL to electrically connect the VGH node to the output node n04. The seventh transistor T7 includes a gate electrode connected to the second control node QB, a first electrode connected to the output node n04, and a second electrode connected to the VGH node. A third capacitor C3 is connected between the second control node QB and the VGH node.

When the voltage of the first input node n01 is the gate low voltage VGL, the second transistor T2 is turned on and the voltage of the buffer node n03 rises to the gate high voltage VGH. As a result, the third transistor T3 is turned off when the voltage of the first input node n01 is the gate low voltage VGL. Only when the voltage of the first input node n01 is the gate high voltage VGH, the third transistor T3 can be turned on according to the voltage of the second input node n02. In other words, when the voltage of the first input node n01 is the gate high voltage VGH and the voltage of the second input node n02 is the gate low voltage, the third transistor T3 is turned on to electrically connect the second control node QB to the second input node n02 and to discharge the voltage of the second control node QB to the gate low voltage VGL.

In order to control each pixel line as a pixel line of a refresh pixel area or a pixel line of a skip pixel area, the gate driver 120 can include a switching circuit 500 and diodes D1 to D5 as shown in FIG. 22.

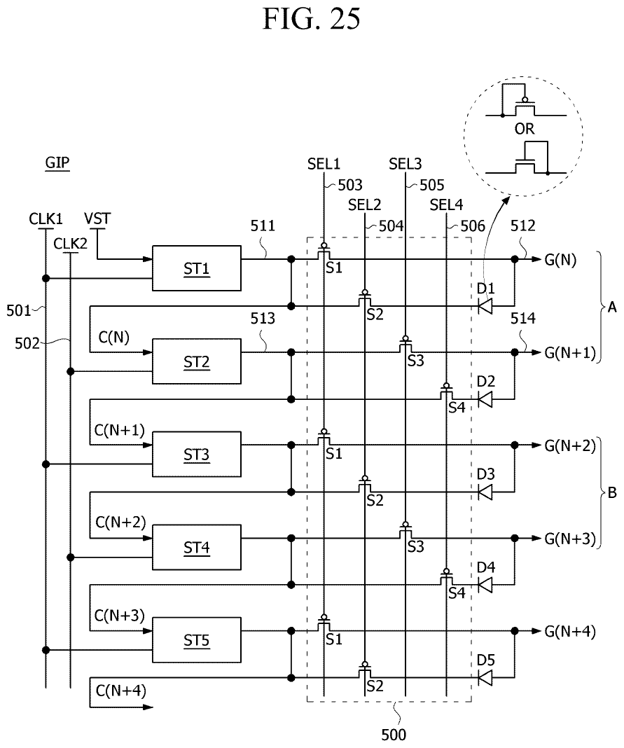

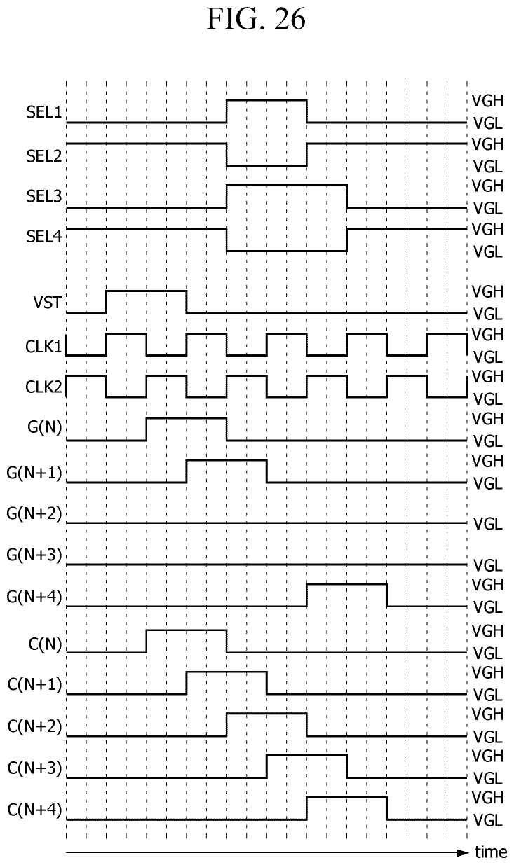

FIG. 25 is a circuit diagram showing switching circuits and diodes of a gate driver according to the first embodiment of the present disclosure. FIG. 26 is a waveform diagram showing input/output signals of the gate driver illustrated in FIG. 25.

Referring to FIGS. 25 and 26, the gate driver GIP includes a plurality of signal transmitters ST1 to ST5, a switching circuit 500 connected to the signal transmitters ST1 to ST5, and a plurality of diodes D1 to D5 connected between the switching circuit 500 and gate lines 512.

The signal transmitters ST1 to ST5 are connected cascaded via carry signal wires. The signal transmitters ST1 to ST5 include a first input node to which a start pulse VST or carry signals C(N) to C(N+4) are input, a second input node connected to clock wires 501 and 501 to which the clocks CLK1 and CLK2 are input, and output nodes 511 and 513 from which a gate signal is output to sequentially output pulses of gate signals. The output node of the (N)th signal transmitter (N is a natural number) is connected to the gate lines via a plurality of switching transistors S1 to S4 of the switching circuit 500 and is also connected to the first input node of the (N+1)th signal transmitter. A gate signal output from the (N)th signal transmitter can be applied to the gate line 512 via the switching circuit 500 and can be input to the first input node of the (N+1)th signal transmitter, which is the next stage, as a carry signal.

The switching circuit 500 selectively connects the output nodes 511 and 513 of each of the signal transmitters ST1 to ST5 to the gate lines 512 and 514 and diodes D1 to D5 in response to selection signals SEL1 to SEL4 using the plurality of switching transistors S1 to S4. The switching circuit 500 selects a refresh pixel area A and a skip pixel area B under the control of a timing controller 130. The timing controller 130 can freely control the refresh rate, size, position, and the like of the refresh pixel area A and the skip pixel area B on a pixel line by pixel line basis for each frame period by using the selection signals SEL1 to SEL4 which control the switching transistors S1 to S4 of the switching circuit 500.

The switching circuit 500 includes the first switching transistor S1 connected between the output node 511 of the first signal transmitter ST1 from which an (N)th gate signal G(N) is output and the Nth gate line 512, the second switching transistor S2 connected between the output node 513 of the first signal transmitter ST1 and the first diode D1, the third switching transistor S3 connected between the output node 511 of the second signal transmitter ST2 from which an (N+1)th gate signal G(N+1) is output and the Nth gate line 512, and the fourth switching transistor S4 connected between the output node 513 of the second signal transmitter ST2 and the second diode D2. The (N)th gate signal G(N) can be a first gate signal, and the N+1th gate signal G(N+1) can be a second gate signal. Active layers of the switching transistors may be formed of a semiconductor material, such as polycrystalline semiconductor, but is not limited thereto. The polycrystalline semiconductor material has a fast movement speed of carriers such as electrons and holes and thus has high mobility, and has low energy power consumption and superior reliability. The polycrystalline semiconductor may be made of polycrystalline silicon (poly-Si), but is not limited thereto. For example, the switching transistors S1 to S4 can be implemented as p-channel LTPS TFTs, but are not limited thereto.

The diodes D1 to D5 act as switching elements that turn on when the voltage at the output node of the signal transmitter is the gate-off voltage and the voltage at the gate line is the gate-on voltage. The diodes D1 to D5 are connected between the output node of the signal transmitter and the gate line to satisfy the above described turn-on conditions. For example, when the switching transistor of the pixel circuit is an n-channel oxide TFT, as shown in FIG. 25, the anode electrodes of the diodes D1 to D5 are connected to the gate lines 512 and 514, and the cathode electrodes of the diodes D1 to D5 are connected to the output nodes 511 and 513 of the signal transmitter. In the case of an n-channel oxide TFT, the gate-off voltage is the gate low voltage VGL and the gate-on voltage is the gate high voltage VGH, as shown in FIG. 26.

The diodes D1 to D5 can be implemented as transistors having substantially the same structure as the transistors of the pixel circuit, for example, p-channel LTPS TFTs or n-channel oxide TFTs. A transistor can operate as a diode when the gate electrode is connected to either the first or second electrode. Accordingly, the switching transistors S1 to S4 and the diodes D1 to D5 of the switching circuit 500 can be located on the display panel 100 together with the pixel circuit.

The first switching transistor S1 is connected between the output node 511 of the (N)th signal transmitter and the Nth gate line 512 and is turned on in response to the first selection signal SEL1. When the first switching transistor S1 is a p-channel transistor, the first switching transistor S1 is turned on at the gate low voltage VGL of the first selection signal SEL1. When the first switching transistor S1 is turned on, the output node 511 of the (N)th signal transmitter is connected to the Nth gate line 512. In this case, a pulse of a gate signal output from the (N)th signal transmitter can be applied to the Nth gate line 512. The first switching transistor S1 includes a first electrode connected to the output node 511 of the (N)th signal transmitter, a gate electrode connected to a first selection signal wire 503 to which the first selection signal SEL1 is applied, and a second electrode connected to the Nth gate line 512.

The second switching transistor S2 is connected between the output node 511 of the (N)th signal transmitter and the Nth diode D1, D3, and D5 and is turned on in response to the gate low voltage VGL of the second selection signal SEL2. When the second switching transistor S2 is turned on, the output node 511 of the (N)th signal transmitter is connected to the Nth diodes D1, D3, and D5. When the second switching transistor S2 and the Nth diodes D1, D3, and D5 are turned on, the Nth gate line 512 can be electrically connected to the output node of the (N)th signal transmitter. The second switching transistor S2 includes a first electrode connected to the output node 511 of the (N)th signal transmitter, a gate electrode connected to a second selection signal wire 504 to which the second selection signal SEL2 is applied, and a second electrode connected to the Nth gate line 512.

The third switching transistor S3 is connected between the output node 513 of the (N+1)th signal transmitter and the (N+1)th gate line 514 and is turned on in response to the third selection signal SEL3. When the third switching transistor S3 is a p-channel transistor, the third switching transistor S3 is turned on at the gate low voltage VGL of the third selection signal SEL3. When the third switching transistor S3 is turned on, the output node 513 of the (N+1)th signal transmitter is connected to the (N+1)th gate line 514. In this case, a pulse of a gate signal output from the (N+1)th signal transmitter can be applied to the (N+1)th gate line 514. The third switching transistor S3 includes a first electrode connected to the output node 513 of the (N+1)th signal transmitter, a gate electrode connected to a third selection signal wire 505 to which the third selection signal SEL3 is applied, and a second electrode connected to the (N+1) gate line 514.

The fourth switching transistor S4 is connected between the output node 513 of the (N+1)th signal transmitter and the (N+1)th diodes D2 and D4 and is turned on in response to the gate low voltage VGL of the fourth selection signal SEL4. When the fourth switching transistor S4 is turned on, the output node 513 of the (N+1)th signal transmitter is connected to the N+1th diodes D2 and D4. When the fourth switching transistor S4 and the (N+1)th diodes D2 and D4 are turned on, the N+1th gate line 514 can be electrically connected to the output node of the (N+1)th signal transmitter. The fourth switching transistor S4 includes a first electrode connected to the output node 513 of the (N+1)th signal transmitter, a gate electrode connected to a fourth selection signal wire 506 to which the fourth selection signal SEL4 is applied, and a second electrode connected to the (N+1)th gate line 514.

According to voltages of first and fourth gate signals SC1(n) and SC4(n) input to the pixel circuit shown in FIG. 4, the pixel circuit can operate as sub-pixels in a refresh pixel area or a skip pixel area. The gate driver illustrated in FIG. 25 can output the first and fourth gate signals SC1(n) and SC4(n). In FIG. 25, G(N), G(N+1), and G(N+4) can be at least one of the first and fourth gate signals SC1(n) and SC4(n) input to the pixel circuit of a refresh pixel area A having a high refresh rate. G(N+2) and G(N+3) can be at least one of the first and fourth gate signals SC1(n) and SC4(n) input to the pixel circuit of a skip pixel area B having a low refresh rate.

According to the voltages of the first, second, third, and fourth gate signals SC1, SC2, SC3, and EM1 input to the pixel circuit shown in FIG. 9, the pixel circuit can operate as a sub-pixel of a refresh pixel area or a skip pixel area. The gate driver shown in FIG. 25 can output the first, second, third, and fourth gate signals SC1, SC2, SC3, and EM1. In FIG. 25, G(N), G(N+1), and G(N+4) can be at least one of the first, second, third, and fourth gate signals SC1, SC2, SC3, and EM1 input to the pixel circuit of the refresh pixel area A having a high refresh rate. G(N+2) and G(N+3) can be at least one of the first, second, third, and fourth gate signals SC1, SC2, SC3, and EM1 input to the pixel circuit of the skip pixel area B having a low refresh rate.

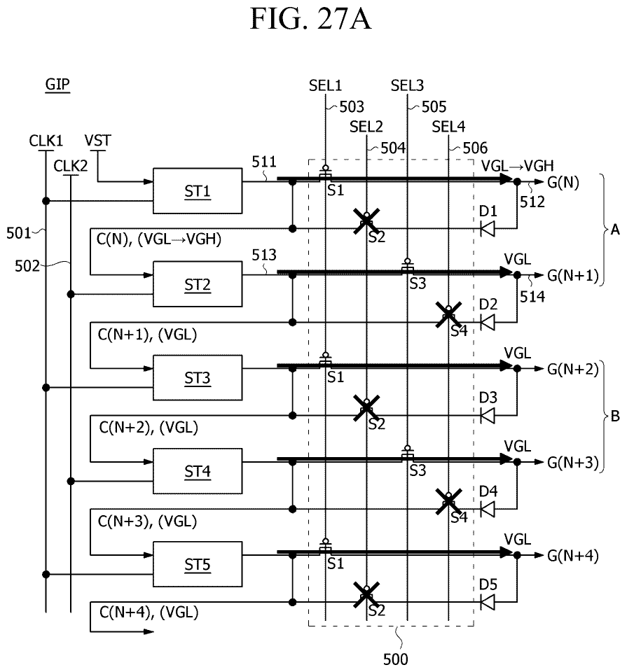

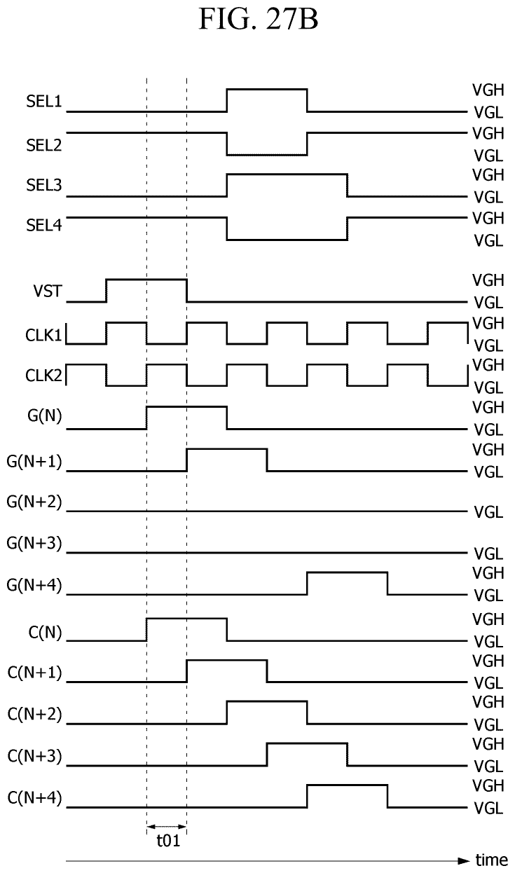

The operation of the gate driver shown in FIG. 25 will be explained in conjunction with FIGS. 27A to 31B.

Referring to FIGS. 27A and 27B, the voltage of the start pulse VST is the gate high voltage VGH during a period t01. During the period t01, the voltage of the first clock CLK1 is the gate low voltage VGL, and the voltage of the second clock CLK2 is the gate high voltage VGH. During the period t01, the voltages of the first and third selection signals SEL1 and SEL3 are gate low voltages VGL, and the voltages of the second and fourth selection signals SEL2 and SEL4) are gate high voltages VGH. When the switching transistors S1 to S4 of the switching circuit 500 are p-channel transistors, the first and third switching transistors S1 and S3 are turned on during the period t01, and the second and fourth switching transistors S2 and S4 are turned off during the period t01.

The first signal transmitter ST1 receives a start pulse VST of the gate high voltage VGH and a first clock CLK1 of the gate low voltage VGL during the period t01. As a result, the voltage of the (N)th gate signal G(N) output from the first signal transmitter ST1 is inverted to the gate high voltage VGH at the beginning of the period t01. The voltage of the gate signals G(N+1) to G(N+4) output from the second to fifth signal transmitter ST2 to ST5 is the gate low voltage VGL during the period t01.

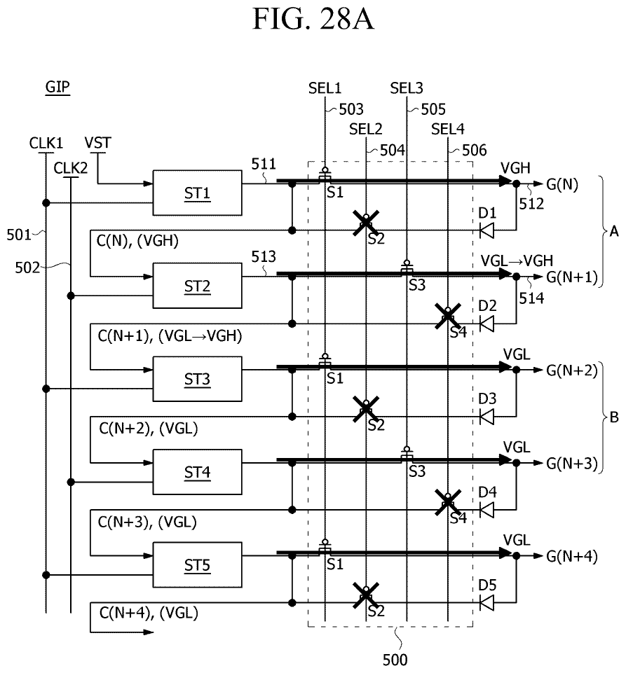

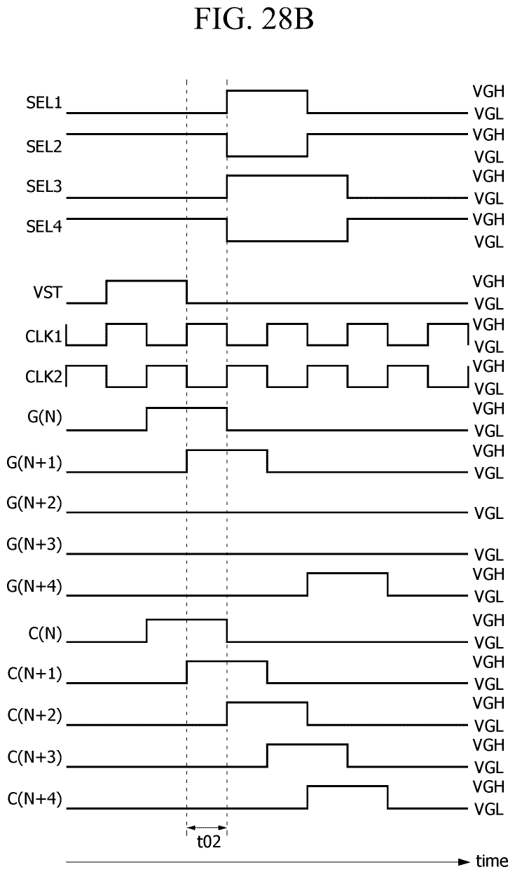

Referring to FIGS. 28A and 28B, the voltage of the start pulse VST is the gate low voltage VGL during a period t02. During the period t02, the voltage of the first clock CLK1 is the gate high voltage VGH, and the voltage of the second clock CLK2 is the gate low voltage VGL. During the period t02, the voltages of the first and third selection signals SEL1 and SEL3 are the gate low voltages VGL, and the voltages of the second and fourth selection signals SEL2 and SEL4 are the gate high voltages VGH. Therefore, the first and third switching transistors S1 and S3 are in the on state during the period t02, and the second and fourth switching transistors S2 and S4 are in the off state during the period t02.

The voltage of the (N)th gate signal G(N) output from the first signal transmitter ST1 is the gate high voltage VGH during the period t02. The second signal transmitter ST2 receives a (N)th carry signal C(N) of the gate high voltage VGH and the second clock CLK2 of the gate low voltage VGL during the period t02. As a result, the voltage of the (N+1)th gate signal G(N+1) output from the second signal transmitter ST2 is inverted to the gate high voltage VGH at the beginning of the period t02. The voltage of the gate signals G(N+2), G(N+3), and G(N+4) output from the third to fifth signal transmitters ST3, ST4, and ST5 is the gate low voltage VGL during the period t02.

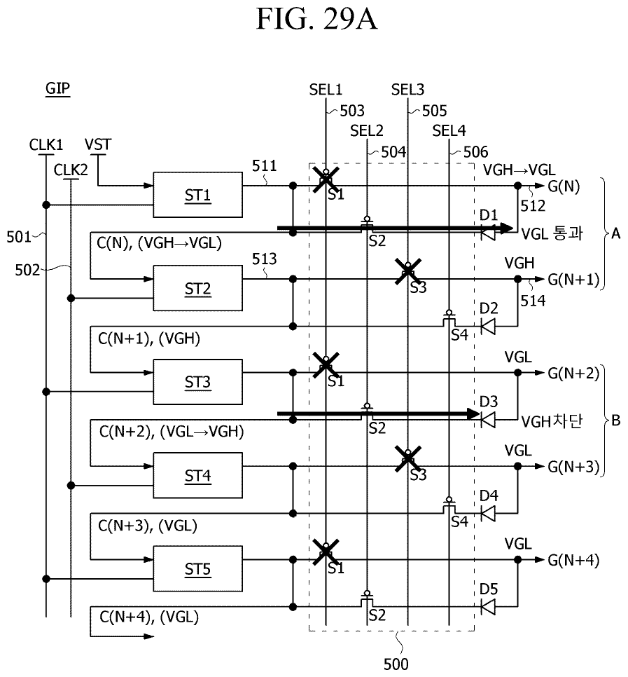

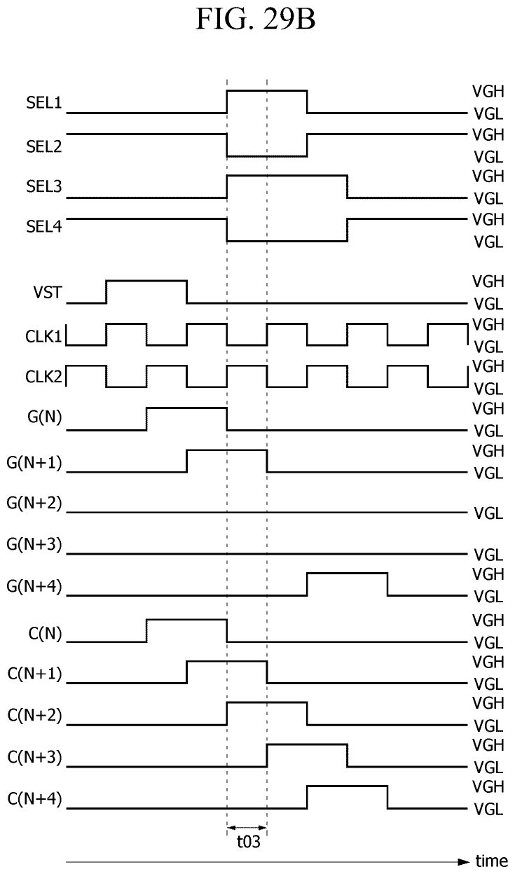

Referring to FIGS. 29A and 29B, the voltage of the start pulse VST during a period t03 is the gate low voltage VGL. During the period t03, the voltage of the first clock CLK1 is the gate low voltage VGL, and the voltage of the second clock CLK2 is the gate high voltage VGH. During the period t03, the voltages of the first and third selection signals SEL1 and SEL3 are the gate high voltages VGH, and the voltages of the second and fourth selection signals SEL2 and SEL4 are the gate low voltages VGL. Therefore, the second and fourth switching transistors S2 and S4 are turned on during the period t03, and the first and third switching transistors S1 and S3 are turned off during the period t03.

The first signal transmitter ST1 receives the start pulse VST of the gate low voltage VGL and the first clock CLK1 of the gate low voltage VGL during the period t03. As a result, the output voltage of the first signal transmitter ST1 is inverted to the gate low voltage VGL at the beginning of the period t03. The output voltage of the first signal transmitter ST1 is supplied to the first diode D1 via the second switching transistor S2. In this case, since the anode voltage of the first diode D1 is the gate high voltage VGH and the cathode voltage thereof is the gate low voltage VGL, the first diode D1 is turned on and the voltage of the (N)th gate signal G(N) is inverted from the gate high voltage VGH to the gate low voltage VGL at the beginning of the period t03. If the first diode D1 is not present, the voltage of the (N)th gate signal G(N) is maintained at the gate high voltage VGH during the period t03, and an abnormal gate signal pulse is applied to the pixel circuit of the refresh pixel area A, which can cause a malfunction.

The voltage of the (N+1)th gate signal G(N+1) is the gate high voltage VGH during the period t03. The third signal transmitter ST3 receives the (N)th carry signal C(N+1) of the gate high voltage VGH and the first clock CLK1 of the gate low voltage VGL during the period t03. As a result, the output voltage of the third signal transmitter ST3 is inverted to the gate high voltage VGH at the beginning of the period t03. The output voltage of the third signal transmitter ST3 is supplied to the third diode D3 via the second switching transistor S2, but since the third diode D3 is not turned on, the voltage of the (N+2)th gate signal G(N+2) maintains the gate low voltage during the period t03. If the third diode D3 is not present, the voltage of the (N+2)th gate signal G(N+2) is changed to the gate high voltage VGH during the period t03, and an abnormal gate signal pulse is applied to the pixel circuit of the skip pixel area B, which can cause a malfunction. The voltages of the (N+3)th and (N+4)th gate signals G(N+3) and G(N+4) is the gate low voltage VGL during the period t03.

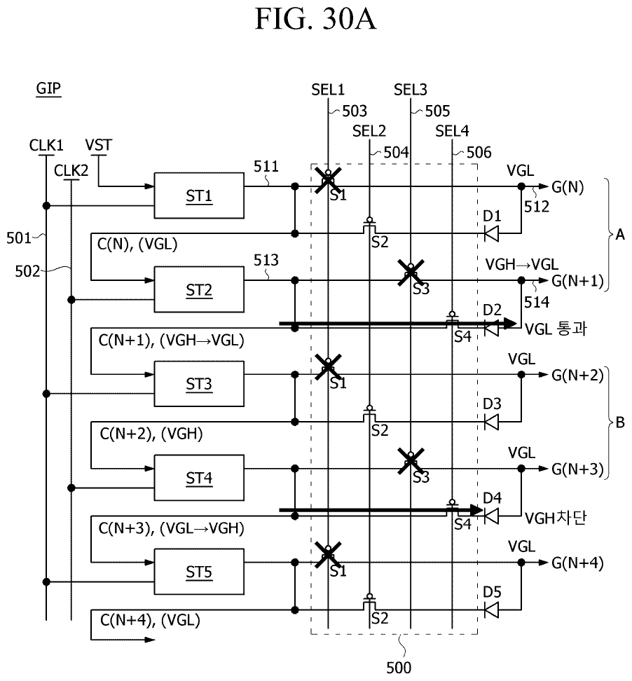

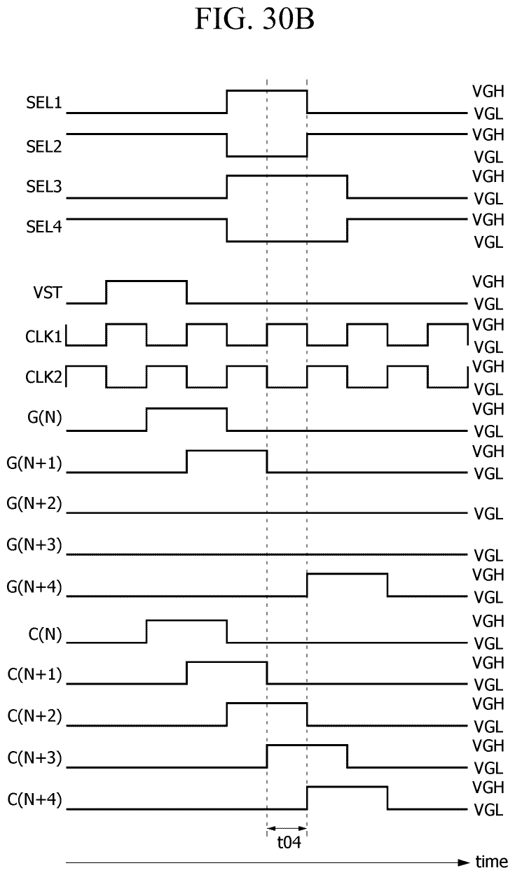

Referring to FIGS. 30A and 30B, the voltage of the start pulse VST is the gate low voltage VGL during a period t04. During the period t04, the voltage of the first clock CLK1 is the gate high voltage VGH, and the voltage of the second clock CLK2 is the gate low voltage VGL. During the period t04, the voltages of the first and third selection signals SEL1 and SEL3 are the gate high voltages VGH, and the voltages of the second and fourth selection signals SEL2 and SEL4 are the gate low voltages VGL. Therefore, the second and fourth switching transistors S2 and S4 are in the on state during the period t04, and the first and third switching transistors S1 and S3 are in the off state during the period t04.

The voltage of the (N)th gate signal G(N) is the gate low voltage VGL during the period t04. The second signal transmitter ST2 receives the (N)th carry signal C(N) of the gate low voltage VGL and the second clock CLK2 of the gate low voltage VGL during the period t04. As a result, the output voltage of the second signal transmitter ST2 is inverted to the gate low voltage VGL at the beginning of the period t04. The output voltage of the second signal transmitter ST2 is supplied to the second diode D2 via the fourth switching transistor S4. In this case, since the anode voltage of the second diode D2 is the gate high voltage VGH and the cathode voltage thereof is the gate low voltage VGL, the second diode D2 is turned on and the voltage of the N+1th gate signal G(N+1) is inverted from the gate high voltage VGH to the gate low voltage VGL at the beginning of the period t04.

The third signal transmitter ST3 receives the (N+1)th carry signal C(N+1) of the gate low voltage VGL and the first clock CLK1 of the gate high voltage VGH during the period t04. The voltage of the (N+2)th gate signal G(N+2) is the gate low voltage VGL during the period t04.

The fourth signal transmitter ST4 receives the (N+2)th carry signal C(N+2) of the gate high voltage VGH and the second clock CLK2 of the gate low voltage VGL during the period t04. As a result, the output voltage of the fourth signal transmitter ST4 is the gate high voltage VGH at the beginning of the period t04, and this voltage is supplied to the fourth diode D4 via the fourth switching transistor S4. In this case, since the fourth diode D4 is in the off state, the voltage of the (N+3)th gate signal G(N+3) is the gate low voltage VGL during the period t04. The voltage of the (N+4)th gate signal G(N+4) is the gate low voltage VGL during the period t04.

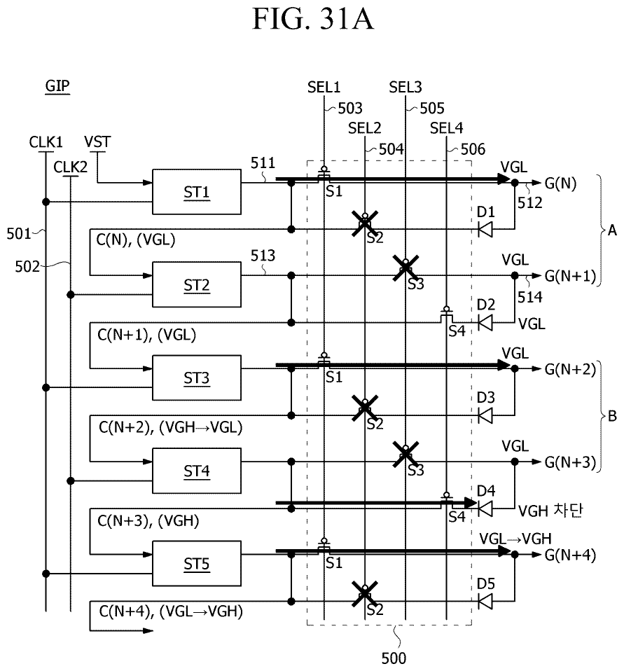

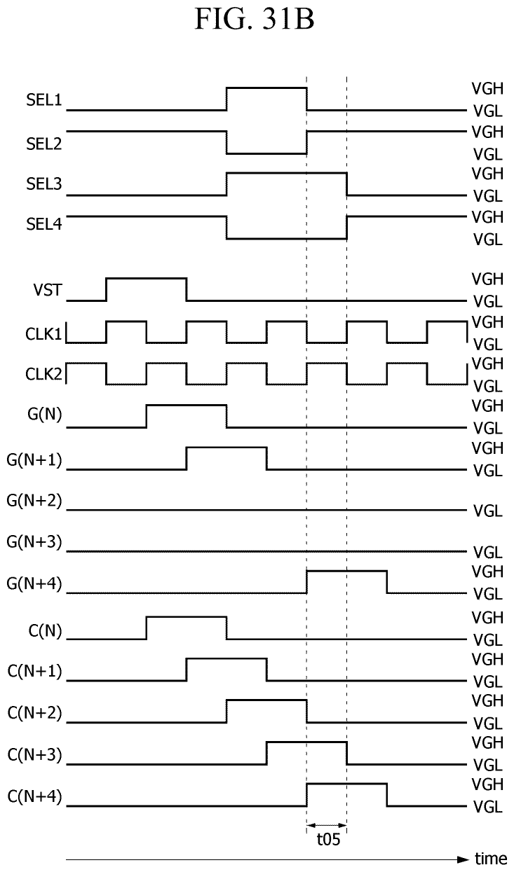

Referring to FIGS. 31A and 31B, the voltage of the start pulse VST is the gate low voltage VGL during a period t05. During the period t05, the voltage of the first clock CLK1 is the gate low voltage VGL, and the voltage of the second clock CLK2 is the gate high voltage VGH. During the t05 period, the voltages of the first and fourth selection signals SEL1 and SEL4 are the gate low voltages VGL, and the voltages of the second and third selection signals SEL2 and SEL3 are the gate high voltages VGH. Therefore, the first and fourth switching transistors S1 and S4 are in the on state during a period t05, and the second and third switching transistors S2 and S3 are in the off state during the period t05.

The voltages of the Nth and N+1th gate signals G(N) and G(N+1) are the gate low voltage VGL during the period t05. The third signal transmitter ST3 receives the (N+1)th carry signal C(N+1) of the gate low voltage VGL and the first clock CLK1 of the gate low voltage VGL during the period t05. As a result, during the period t05, the gate low voltage VGL output from the third signal transmitter ST3 is supplied to the (N+2)th gate line via the first switching transistor S1. Therefore, the voltage of the (N+2)th gate signal G(N+2) is the gate low voltage VGL during the period t05. In this case, the second diode D2 is in the off state.

The fourth signal transmitter ST4 receives the (N+2)th carry signal C(N+2) that is changed from the gate high voltage VGH to the gate low voltage VGL and the second clock CLK2 of the gate high voltage VGH during the period t05. When the voltage of the (N+2)th carry signal C(N+2) is the gate high voltage VGH, the fourth diode D4 is in the off state. Therefore, the voltage of the (N+3)th gate signal G(N+3) is the gate low voltage VGL during the period t05.

The fifth signal transmitter ST5 receives the (N+3)th carry signal C(N+3) of the gate high voltage VGH and the first clock CLK1 of the gate low voltage VGL during the period t05. As a result, during the period t05, the gate high voltage VGH output from the fifth signal transmitter ST5 is supplied to the (N+4)th gate line via the first switching transistor S1. Therefore, the voltage of the (N+4)th gate signal G(N+4) is the gate low voltage VGL during the period t05.

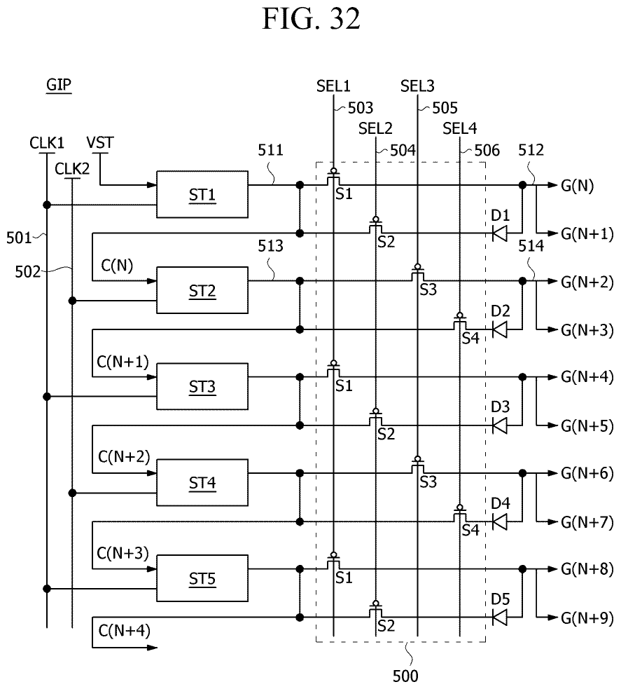

FIG. 32 is a circuit diagram showing switching circuits and diodes of a gate driver according to the second embodiment of the present disclosure. In this embodiment, the components which are substantially the same as those in the embodiment described above are given the same drawing reference numerals and redundant descriptions thereof are omitted or briefly discussed. In FIG. 32, G(N) to G(N+9) is the gate signals.

Referring to FIG. 32, the output nodes of the signal transmitters ST1 to ST5 can be electrically connected to gate lines branched in two by a switching circuit 500. Accordingly, the gate signals output from the signal transmitters ST1 to ST5 can be supplied to gate lines shared by sub-pixels of the two pixel lines.

For example, the gate signal output from the first signal transmitter ST1 can be supplied to the sub-pixels of the Nth pixel line as a (N)th gate signal G(N) via the switching circuit 500 and at the same time, can be supplied to the sub-pixels of the Nth pixel line as an (N+1)th gate signal G(N+1). The gate signal output from the second signal transmitter ST2 can be supplied to the sub-pixels of the (N+2)th pixel line as the (N+2)th gate signal G(N+2) and at the same time, can be supplied to the sub-pixels of the (N+3)th pixel line as the (N+3)th gate signal G(N+3). The gate signal output from the third signal transmitter ST3 may be supplied to the sub-pixels of the (N+4)th pixel line as the (N+4)th gate signal G(N+4) and at the same time, may be supplied to the sub-pixels of the (N+5)th pixel line as the (N+5)th gate signal G(N+5). The gate signal output from the fourth signal transmitter ST4 may be supplied to the sub-pixels of the (N+6)th pixel line as the (N+6)th gate signal G(N+6) and at the same time, may be supplied to the sub-pixels of the (N+7)th pixel line as the (N+7)th gate signal G(N+7). The gate signal output from the fifth signal transmitter ST5 may be supplied to the sub-pixels of the (N+8)th pixel line as the (N+8)th gate signal G(N+8) and at the same time, may be supplied to the sub-pixels of the (N+9)th pixel line as the (N+9)th gate signal G(N+9). However, the present disclosure is not limited thereto.

The gate driver shown in FIG. 32 can supply the gate signals to the sub-pixels shown in FIG. 15.

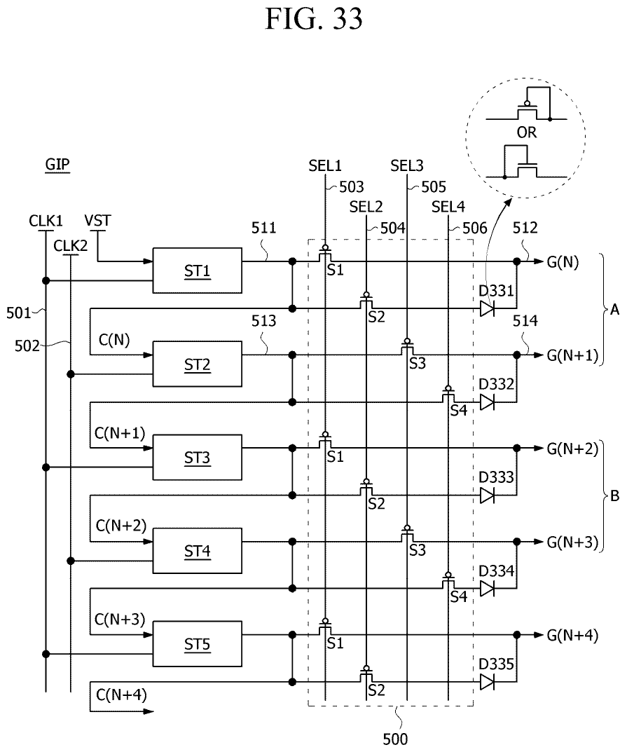

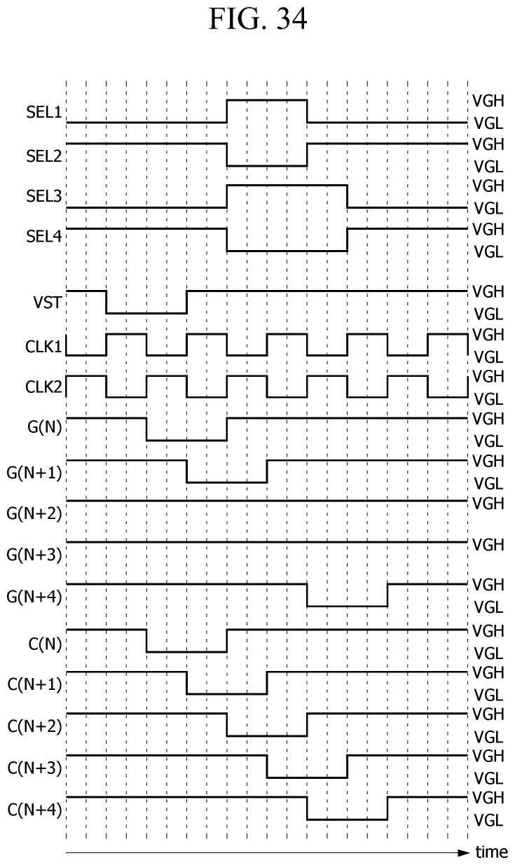

FIG. 33 is a circuit diagram showing switching circuits and diodes of a gate driver according to the third embodiment of the present disclosure. FIG. 34 is a waveform diagram showing the input/output signals of the gate driver illustrated in FIG. 33. In this embodiment, the components which are substantially the same as those in the embodiment described above are given the same drawing reference numerals and redundant descriptions thereof are omitted or briefly discussed.

Referring to FIGS. 33 and 34, the switching circuit 500 selectively connects the output nodes 511 and 513 of each of the signal transmitters ST1 to ST5 to the gate lines 512 and 514 and diodes D331 to D335 in response to the selection signals SEL1 to SEL4.

The diodes D331 to D335 act as switching elements that turn on when the voltage at the output node of the signal transmitter is the gate-off voltage and the voltage at the gate line is the gate-on voltage. The diodes D331 to D335 are connected between the output node of the signal transmitter and the gate line to satisfy the turn-on conditions above described. For example, when the switching transistor of the pixel circuit is a p-channel LTPS TFT, as shown in FIG. 33, the cathode electrodes of the diodes D331 to D335 are connected to the gate lines 512 and 514, and the anode electrodes of the diodes D331 to D335 are connected to the output nodes 511 and 513 of the signal transmitter. In the case of the p-channel LTPS TFT, the gate-off voltage is the gate high voltage VGH and the gate-on voltage is the gate low voltage VGL, as shown in FIG. 34. The diodes D331 to D335 can be implemented as transistors having substantially the same structure as the transistors of the pixel circuit, for example, p-channel LTPS TFTs or n-channel oxide TFTs.

According to the voltages of the gate signal SCAN1 and SCAN2 input to the pixel circuit shown in FIG. 15, the pixel circuit can operate as a sub-pixel in the refresh pixel area or the skip pixel area. The gate driver shown in FIG. 33 can output the gate signals SCAN1 and SCAN2. In FIG. 33, G(N), G(N+1), and G(N+4) can be the gate signals SCAN1 and SCAN2 input to the pixel circuit of the refresh pixel area A having a high refresh rate. G(N+2) and G(N+3) can be the gate signals SCAN1 and SCAN2 input to the pixel circuit of the skip pixel area B having a low refresh rate.

The display device according to an embodiment of the present disclosure can be applied to a mobile device, a video phone, a smart watch, a watch phone, a wearable apparatus, a foldable apparatus, a rollable apparatus, a bendable apparatus, a flexible apparatus, a curved apparatus, a sliding apparatus, a variable apparatus, an electronic notebook, an electronic book, a portable multimedia player (PMP), a personal digital assistant (PDA), an MP3 player, a mobile medical device, a desktop PC, a laptop PC, a netbook computer, a workstation, a navigation system, a vehicle display device, a theater display device, a television, a wallpaper device, a signage device, a game device, a notebook, a monitor, a camera, a camcorder, a home appliance, and the like. In addition, the display device according to one or more embodiments of the present disclosure can be applied to an organic light-emitting lighting device or an inorganic light-emitting lighting device.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A gate driving circuit comprising:
a first switching transistor connected between a first gate line and an output node of a first signal transmitter configured to output a first gate signal;
a second switching transistor connected to the output node of the first signal transmitter;
a first diode connected between the second switching transistor and the first gate line;
a third switching transistor connected between a second gate line and an output node of a second signal transmitter configured to output a second gate signal;
a fourth switching transistor connected to the output node of the second signal transmitter; and
a second diode connected between the fourth switching transistor and the second gate line.

2. The gate driving circuit of claim 1, wherein the output node of the first signal transmitter configured to be selectively connected to the first gate line and the first diode, in response to selection signals input to gate electrodes of the first switching transistor and the second switching transistor, respectively.

3. The gate driving circuit of claim 1.3, wherein the output node of the second signal transmitter configured to be selectively connected to the second gate line and the second diode, in response to selection signals input to gate electrodes of the third switching transistor and the fourth switching transistor, respectively.

4. The gate driving circuit of claim 1, wherein the first diode includes a cathode electrode connected to the second switching transistor and an anode electrode connected to the first gate line, and
the second diode includes a cathode electrode connected to the fourth switching transistor and an anode electrode connected to the second gate line.

5. The gate driving circuit of claim 1, wherein the first diode includes an anode electrode connected to the second switching transistor and a cathode electrode connected to the first gate line, and
the second diode includes an anode electrode connected to the fourth switching transistor and a cathode electrode connected to the second gate line.

6. The gate driving circuit of claim 1, wherein each of the first and second diodes includes a transistor having a gate connected to one of the first and second electrodes.

7. The gate driving circuit of claim 1, wherein the first signal transmitter includes:
a first-first input node configured to receive as input a start pulse or a carry signal; and
a second-first input node configured to receive as input a first clock,
wherein the output node of the first signal transmitter is configured to output the first gate signal and a first carry signal,
wherein the second signal transmitter includes:
a first-second input node configured to receive as input the first carry signal; and
a second-second input node configured to receive as input a second clock having a phase different from that of the first clock, and
wherein the output node of the second signal transmitter is configured to output the second gate signal and a second carry signal.

8. The gate driving circuit of claim 1, wherein at least one of the first and second gate lines is branched into two gate lines.

9. A display panel comprising:
a display area in which data lines, gate lines, power lines, and sub-pixels are arranged; and
gate drivers configured to supply gate signals to the gate lines,
wherein at least one of the gate drivers includes:
a first switching transistor connected between a first gate line and an output node of a first signal transmitter from which a first gate signal is output;
a second switching transistor connected to the output node of the first signal transmitter;
a first diode connected between the second switching transistor and the first gate line;
a third switching transistor connected between a second gate line and an output node of a second signal transmitter from which a second gate signal is output;
a fourth switching transistor connected to the output node of the second signal transmitter; and
a second diode connected between the fourth switching transistor and the second gate line.

10. The display panel of claim 9, wherein the first diode includes a cathode electrode connected to the second switching transistor and an anode electrode connected to the first gate line, and
the second diode includes a cathode electrode connected to the fourth switching transistor and an anode electrode connected to the second gate line.

11. The display panel of claim 10, wherein each of the sub-pixels connected to the first and second gate lines includes an n-channel transistor including a gate electrode to which the first gate signal or the second gate signal is applied.

12. The display panel of claim 9, wherein the first diode includes an anode electrode connected to the second switching transistor and a cathode electrode connected to the first gate line, and
the second diode includes an anode electrode connected to the fourth switching transistor and a cathode electrode connected to the second gate line.

13. The display panel of claim 12, wherein each of the sub-pixels connected to the first and second gate lines includes a p-channel transistor including a gate electrode to which the first gate signal or the second gate signal is applied.

14. The display panel of claim 9, wherein the sub-pixels include:
a first sub-pixel connected to a first data line among the data lines; and
a second sub-pixel connected to a second data line among the data lines, and
wherein the first and second sub-pixels are connected to a same gate line among the gate lines, and
at least one of the first and second gate lines is branched into two gate lines and is connected to the first and second sub-pixels.

15. A display device comprising:
a display panel including a display area in which data lines, gate lines, power lines, and sub-pixels are arranged;
gate drivers supplying gate signals to the gate lines; and
a data driver connected to the data lines,
wherein the display area includes at least first and second pixel areas having different refresh rates,
wherein the sub-pixels of the first pixel area are driven at a first refresh rate, while the sub-pixels of the second pixel area are driven at a second refresh rate that is lower than the first refresh rate, and
wherein at least one of the gate drivers includes:
a first switching transistor connected between a first gate line and an output node of a first signal transmitter from which a first gate signal is output;
a second switching transistor connected to the output node of the first signal transmitter;
a first diode connected between the second switching transistor and the first gate line;
a third switching transistor connected between a second gate line and an output node of the second signal transmitter from which a second gate signal is output;
a fourth switching transistor connected to the output node of the second signal transmitter; and
a second diode connected between the fourth switching transistor and the second gate line.

16. The display device of claim 15, wherein the first diode includes a cathode electrode connected to the second switching transistor and an anode electrode connected to the first gate line, and
the second diode includes a cathode electrode connected to the fourth switching transistor and an anode electrode connected to the second gate line.

17. The display device of claim 16, wherein each of the sub-pixels connected to the first and second gate lines includes an n-channel transistor including a gate electrode to which the first gate signal or the second gate signal is applied.

18. The display device of claim 15, wherein the first diode includes an anode electrode connected to the second switching transistor and a cathode electrode connected to the first gate line, and
the second diode includes an anode electrode connected to the fourth switching transistor and a cathode electrode connected to the second gate line.

19. The display device of claim 18, wherein each of the sub-pixels connected to the first and second gate lines includes a p-channel transistor including a gate electrode to which the first gate signal or the second gate signal is applied.

20. The display device of claim 15, wherein the sub-pixels include:
a first sub-pixel connected to a first data line among the data lines; and
a second sub-pixel connected to a second data line among the data lines, and
wherein the first and second sub-pixels are connected to a same gate line among the gate lines, and
at least one of the first and second gate lines is branched into two gate lines and is connected to the first and second sub-pixels.
